(19) United States
(12) Patent Application Publication
(10) Pub. No.: US 2009/0213311 A1
(43) Pub. Date: Aug. 27, 2009

(54) Liquid Crystal Display Device

(75) Inventors: Yoshiaki Hisakado, Minami-Ashigara-shi (JP); Hiromichi Furukawa, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/388,745

(22) Filed: Feb. 19, 2009

(30) Foreign Application Priority Data
Feb. 21, 2008 (JP) 2008-040508

(51) Int. Cl. G02F 1/13363

(52) U.S. Cl. 349/117

(57) ABSTRACT

A liquid crystal display device includes: a liquid crystal cell; and a pair of polarizing plates sandwiching the liquid crystal cell and each including a polarizer and a protective film provided on a side of the liquid crystal cell, in which transmission axes of the pair of polarizing plates are orthogonally arranged, wherein Rth(λ) of at least one of the protective films provided on the liquid crystal cell side of the polarizing plates has negative characteristics for ambient temperature, in which Rth(λ) represents a retardation in a thickness direction measured at a wavelength of λ nm.

### CROSS-REFERENCE TO RELATED APPLICATIONS

This application claims the benefit of Japanese Patent Application JP 2008-040508, filed Feb. 21, 2008, the entire content of which is hereby incorporated by reference, the same as if set forth at length.

### FIELD OF THE INVENTION

The present invention relates to a liquid crystal display device, more specifically, a liquid crystal display device assured of a high viewing angle over a wide ambient temperature range and small color shift when displayed in black.

### BACKGROUND OF THE INVENTION

A liquid crystal display device is increasingly used year by year as a space-saving, less power-consuming image display device. It has been conventionally a great drawback of the liquid crystal display device that the viewing-angle dependency of the image is large, but in recent years, various high viewing-angle modes differing in the arrayed state of liquid crystal molecules in the liquid crystal cell are put into practical use and this allows rapid spreading of the demand for a liquid crystal display device also in the market where a high viewing angle is required, such as television.

In general, the liquid crystal display device comprises a liquid crystal cell, an optically compensatory sheet and a polarizer. The optically compensatory sheet is used for eliminating image coloration or enlarging the viewing angle, and a stretched birefringent film or a film obtained by coating a liquid crystal on a transparent film is used therefor. For example, Japanese Patent No. 2,587,398 (corresponding to U.S. Pat. No. 5,583,679) discloses a technique of applying an optically compensatory sheet where a discotic liquid crystal is coated on a triacetyl cellulose, aligned and fixed, to a TN-mode liquid crystal cell, thereby enlarging the viewing angle. However, a liquid crystal display device for a large-screen television expected to be seen from various angles imposes severe requirements on the viewing angle dependency, and even the technique above cannot satisfy these requirements. Therefore, studies are being made on a liquid crystal display device different from TN mode, such as IPS (In-Plane Switching) mode, OCB (Optically Compensatory Bend) mode and VA (Vertically Aligned) mode.

In particular, the VA mode ensures high contrast and a relatively high production yield and the liquid crystal display device of this mode is attracting attention as a liquid crystal display device for TV. However, the VA mode has a problem that although the panel may be displayed in almost complete black, light leakage occurs when viewed from an oblique direction and the viewing angle is narrowed.

With respect to this problem, it has been reported that when the relationship among the Re and Rth values of the polarizing plate protective film on the liquid crystal cell side and the Δnd of the liquid crystal cell is set to an appropriate range and furthermore, the color tint in case of orthogonally disposing polarizers and the color temperature of backlight of the liquid crystal display device are set to appropriate ranges, a wide viewing angle and small color shift at the time of black display can be achieved (see, for example, JP-A-2007-140497 (the term “JP-A” as used herein means an “unexamined published Japanese patent application”) (corresponding to WO 2007/046530 A1)). There has been also proposed a technique where almost achromatic black can be displayed with less light leakage over the entire visible light region by providing a retardation film between a liquid crystal cell and a polarizing film, controlling the wavelength dispersion property of this retardation film and furthermore, using a plurality of specific retardation films (see, for example, Japanese Patent No. 3,648,240 (corresponding to US 2004/0239852A1)).

These techniques produce improvements in view of wide viewing angle and black display, but Δnd of the liquid crystal cell changes at high temperatures and because of this reason, the problem that the contrast value decreases in a specific viewing angle direction cannot be solved.

As regards the problem of contrast reduction ascribable to change of Δnd, a technique of providing an optically anisotropic film where retardation is changed in correspondence with the temperature dependency rate of Δnd of the liquid crystal cell has been reported (see, for example, JP-A-2000-155217 (corresponding to U.S. Pat. No. 6,294,231)). However, the optically anisotropic film described in paragraph 9 of JP-A-2000-155217 (corresponding to U.S. Pat. No. 6,294,231) is an optically anisotropic film having specific physical properties obtained by mixing a polymer and a liquid crystal compound or a liquid crystal composition and lacks production suitability as a retardation film, because the liquid crystal compound or liquid crystal composition is a special composition as being “specified to have a glass transition temperature not more than the lower limit of retardation change of the retardation film required, with the isotropic phase transition temperature being selected to match the temperature dependency of Δnd of the liquid crystal cell used in combination”. Also, even if this optically anisotropic film may respond to the change of Δnd associated with the temperature change of the liquid crystal cell, there still remains a problem that the color shift with respect to the wavelength fluctuation cannot be improved.

### SUMMARY OF THE INVENTION

An object of the present invention is to provide a liquid crystal display device assured of a high viewing angle over a wide ambient temperature range and small color shift when displayed in black.

As a result of intensive studies, the present inventors have found that when negative characteristics for the temperature change are imparted to the polarizing plate protective film on the liquid crystal cell side, a liquid crystal display device assured of a wide viewing angle even in the high temperature region where Δnd of the liquid crystal cell decreases, and small color shift when displayed in black can be provided.

The present invention is as follows.

[1] A liquid crystal display device comprising a liquid crystal cell having on both sides thereof a pair of polarizing plates each comprising a polarizer and a protective film, so that transmission axes of the pair of polarizing plates are orthogonally arranged, wherein Rth(λ) of at least one protective film disposed on the liquid crystal cell side of the polarizing plate has negative characteristics for the ambient temperature (wherein Rth is the retardation in the thickness direction and (λ) means that the measurement wavelength is λ nm).

[2] The liquid crystal display device as described in [1], wherein ReA(λ) and RthA(λ) of a protective film A disposed on the liquid crystal cell side of one polarizing plate of the liquid crystal display device each increases as the wavelength becomes larger in the wavelength range of 400 to 700 nm and RthB(λ) of a protective film B disposed on the liquid crystal cell side of another polarizing plate decreases as the wavelength becomes larger in the wavelength range of 400 to 700 nm and has negative characteristics for the ambient temperature (wherein Re is the in-plane retardation and (λ) means that the measurement wavelength is λ nm).

[3] The liquid crystal display device as described in [2], wherein ReA(λ) and RthA(λ) of the protective film A, ReB(λ) and RthB(λ) of the protective film B and Δnd of the liquid crystal cell satisfy the following formulae:

0.5≦RthA(550)/ReA(550)≦10 (i)

30≦RthA(550)≦400 (ii)

0≦ReB(550)≦20 (iii)

0≦RthB(550)≦150 (iv)

200≦Δnd≦800 (v)

(wherein Δn is the difference (ne-no) between extraordinary light refractive index ne and ordinary light refractive index no, and d is the cell gap (unit: nm) of the liquid crystal cell).

[4] The liquid crystal display device as described in [2] or [3], wherein the protective film B is disposed on a viewing-side substrate of the liquid crystal cell.

[5] The liquid crystal display device as described in any one of [2] to [4], wherein the protective film B is a film substantially comprising a cellulose acylate obtained by substituting an acyl group having a carbon number of 2 or more for a hydroxyl group of a glucose unit constituting a cellulose and assuming that the substitution degree by an acyl group for the hydroxyl group at the 2-position of the glucose unit is DS2, the substitution degree by an acyl group for the hydroxyl group at the 3-position is DS3 and the substitution degree by an acyl group for the hydroxyl group at the 6-position is DS6, the cellulose acylate film satisfies the following mathematical formulae (vi) and (vii):

2.0≦DS2+DS3+DS6≦3.0 Mathematical formula (vi):

DS6/(DS2+DS3+DS6)≧0.315 Mathematical formula (vii):

[6] The liquid crystal display device as described in any one of [2] to [5], wherein the protective film B contains at least one member selected from a plasticizer, an ultraviolet absorber, a release accelerator, a dye and a matting agent.

[7] The liquid crystal display device as described in any one of [2] to [6], wherein the protective film B contains one or more kinds of retardation controlling agents which are a rod-like compound or a discotic compound.

[8] The liquid crystal display device as described in [7], wherein the retardation controlling agent is a compound exhibiting crystallinity.

[9] The liquid crystal display device as described in any one of [1] to [8], wherein the liquid crystal cell is in a vertically aligned mode.

According to the present invention, a liquid crystal display device assured of a high viewing angle over a wide ambient temperature range and small color shift when displayed in black can be provided.

### BRIEF DESCRIPTION OF THE DRAWINGS

FIG. 1 is a rough schematic view for explaining a construction example of the VA-mode liquid crystal display device and the case of light being incident on a panel in the panel normal direction.

FIG. 2 is a rough schematic view for explaining a construction example of the VA-mode liquid crystal display device and the case of light being incident on a panel in the panel oblique direction.

FIG. 3 is a rough schematic view for explaining a construction example of the liquid crystal display device in one embodiment of the present invention.

FIG. 4 is a graph showing optical characteristics in one example of the optically compensatory film for use in the present invention.

FIG. 5 is a schematic view of the Poincare sphere used for explaining the change of the polarization state in one example of the liquid crystal display device of the present invention.

FIG. 6 is a schematic view showing the lamination method of a cellulose acylate film in the production of the polarizing plate of the present invention.

FIG. 7 is a cross-sectional view schematically showing the cross-sectional structure of the polarizing plate of the present invention.

FIG. 8 is a cross-sectional view schematically showing the cross-sectional structure of the polarizing plate of the present invention.

FIG. 9 is a cross-sectional view schematically showing the cross-sectional structure of the polarizing plate in Examples of the present invention.

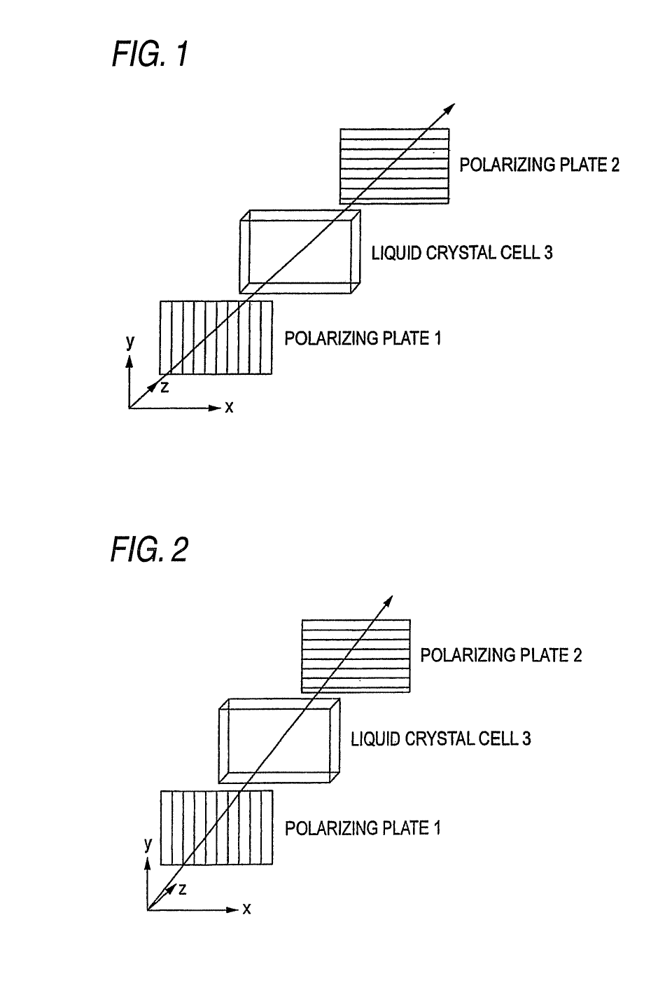

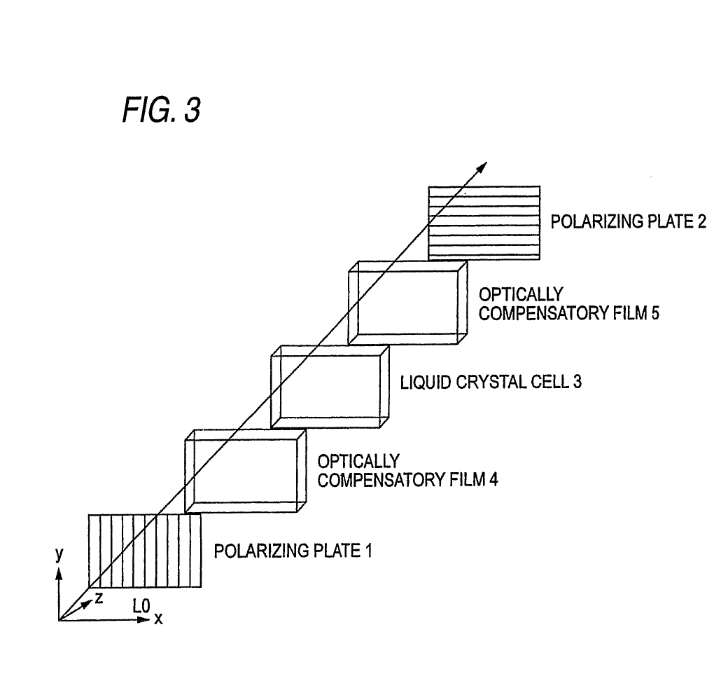

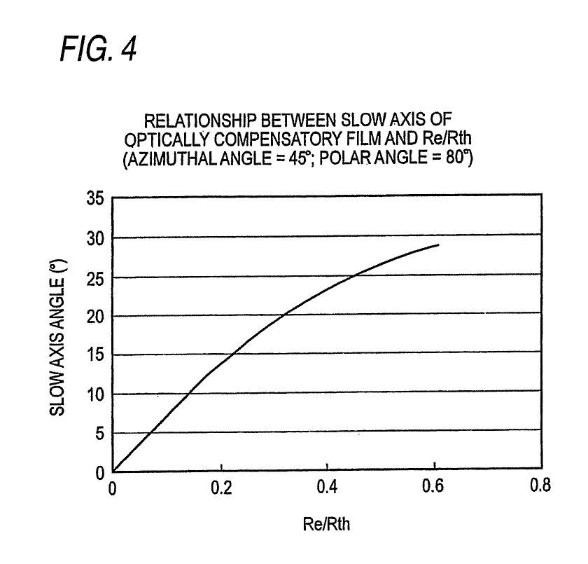

### DETAILED DESCRIPTION OF THE INVENTION

The present invention is described in detail below. In the context of the present invention, the expression “from (numerical value 1) to (numerical value 2)” used for indicating a physical value, a characteristic value or the like means “(numerical value 1) or more and (numerical value 2) or less”. Also, in the context of the present invention, the term “(meth)acryloyl” means “at least either acryloyl or methacryloyl”. The same applies to “(meth)acrylate”, “(meth)acrylic acid” and the like.

The present invention is a liquid crystal display device comprising a liquid crystal cell having disposed on both sides thereof a pair of polarizing plates each comprising a polarizer and a protective film, so that transmission axes of the pair of polarizing plates are orthogonally arranged, wherein the retardation Rth(λ) in the thickness direction of at least one protective film disposed on the liquid crystal cell side of the polarizing plate has negative characteristics for the ambient temperature. In the above, Rth is the retardation in the thickness direction and (λ) means that the measurement wavelength is λ nm.

Here, having a property that the Re and Rth values measured by any one of KOBRA 21ADH, WR, an ellipsometer and a Senarmont method in an environment of a temperature of 25° C. and a humidity of 60% RH each decreases as the temperature in the measurement environment rises is defined as negative temperature dependency (sometimes referred to as “negative characteristics”). Conversely, having a property that the Re and Rth values each increases along the rise of the measurement temperature is defined as a positive temperature dependency (sometimes referred to as a “positive characteristic”).

By virtue of imparting negative characteristics for the temperature change as well as appropriately adjusting the in-plane retardation (Re) and the retardation in the thickness direction and controlling the wavelength dispersion property, reduction in the viewing angle in a high temperature region where Δnd of the liquid crystal display device decreases can be suppressed and the color shift in black display can be reduced.

The effect of suppressing reduction in the viewing angle and the effect of reducing color shift in black display of the present invention are described in detail below.

(Relationship of Re and Rth of Protective Film with Δnd Value of Liquid Crystal Cell)

In the present invention, it has been found that when ReA(λ) and RthA(λ) of a protective film A disposed on the liquid crystal cell side of one polarizing plate of the liquid crystal display device each increases as the wavelength becomes larger in the wavelength range of 400 to 700 nm (sometimes referred to as “reverse dispersion for wavelength”) and RthB(λ) of a protective film B disposed on the liquid crystal cell side of another polarizing plate decreases as the wavelength becomes larger in the wavelength range of 400 to 700 nm and when negative characteristics for the ambient temperature are imparted, a liquid crystal display device assured of a wide viewing angle even in the high temperature region where Δnd decreases, and small color shift in black display can be provided.

For bringing out the effects of the present invention, ReA(λ), RthA(λ), ReB(λ), RthB(λ) and Δnd preferably satisfy the following formulae (i) to (v):

0.5≦RthA(550)/ReA(550)≦10 (i)

30≦RthA(550)≦400 (ii)

0≦ReB(550)≦20 (iii)

0≦RthB(550)≦150 (iv)

200≦Δnd≦800 (v)

In formulae, Δn is the difference (ne-no) between extraordinary light refractive index ne and ordinary light refractive index no, and d is the cell gap (unit: nm) of the liquid crystal cell.

In the present invention, An of the VA-mode liquid crystal cell is from 0.06 to 0.40, preferably from 0.06 to 0.15, and the cell gap of the liquid crystal cell, that is, the thickness of the liquid crystal portion of the liquid crystal cell, is from 2 to 5 μm, preferably from 3 to 4 μm. In the normal VA-mode liquid crystal cell available on the market, Δn tends to decrease as the temperature rises.

In the present invention, the protective film A is preferably provided between the polarizing plate provided on the backlight side and the liquid crystal cell.

In the present invention, ReA(λ) and RthA(λ) of the protective film A preferably have a property of increasing as the wavelength becomes larger in the wavelength range of 400 to 700 nm (sometimes referred to as “reverse dispersion for wavelength”), and satisfy the following formulae (viii) to (iix):

0.75≦ReA(450)/ReA(550)<1.0 Formula (viii):

1.0<ReA(630)/ReA(550)≦1.2 Formula (x):

0.75≦RthA(450)/RthA(550)<1.0 Formula (ix):

1.0<RthA(630)/RthA(550)≦1.2 Formula (iix):

It is more preferred to satisfy formulae (viii′) to (iix′):

0.80≦ReA(450)/ReA(550)<0.95 Formula (viii′):

1.0<ReA(630)/ReA(550)≦1.1 Formula (x′):

0.80≦RthA(450)/RthA(550)<0.95 Formula (ix′):

1.0<RthA(630)/RthA(550)≦1.1 Formula (iix′):

In the present invention, RthB(λ) of the protective film B preferably has a property of decreasing as the wavelength becomes larger in the wavelength range of 400 to 700 nm (sometimes referred to as “forward dispersion for wavelength”), and satisfies the following formulae (iiix) and (ivx):

1.2≦RthB(450)/RthB(550)≦1.0 Formula (iiix):

1.0≦RthB(630)/RthB(550)≦0.8 Formula (ivx):

It is more preferred to satisfy formulae (iiix′) and (ivx′):

1.1≦RthB(450)/RthB(550)≦1.0 Formula (iiix′):

1.0≦RthB(630)/RthB(550)≦0.85 Formula (ivx′):

In the present invention, ReB(550) of the protective film is preferably from 0 to 20, more preferably from 0 to 10.

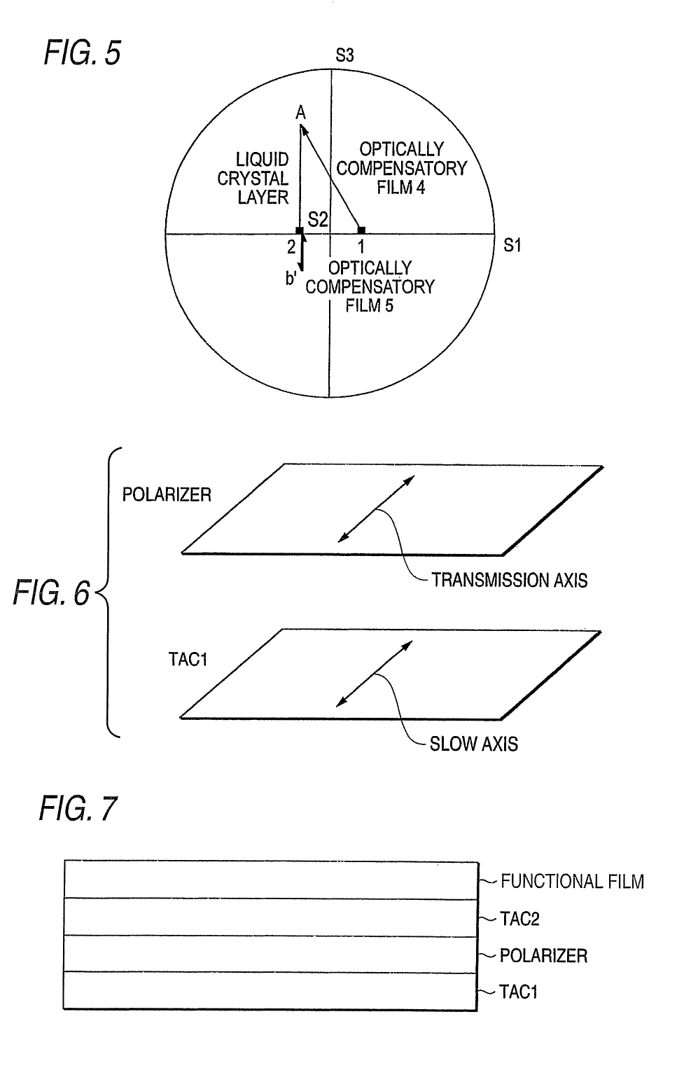

In the present invention, the protective film A is used for the liquid crystal cell-side protective film of the backlight-side polarizing plate of the VA-type liquid crystal display device and the protective film B is used for the liquid crystal cell-side protective film of the front-side polarizing plate, whereby a liquid crystal display device assured of small color shift can be produced. The operation mechanism thereof has been heretofore explained using a Poincare sphere and is not described in detail here, but the operation mechanism may be briefly described as follows by using FIG. 5 of JP-A-2007-140497.

In the Poincare sphere of FIG. 5 of JP-A-2007-140497, the propagation direction of light is at an azimuth of 45° and a polar angle of 34°. In FIG. 5, the S2 axis is an axis vertically penetrating from top to bottom on the paper, and FIG. 5 is a view when viewing the Poincare sphere from the positive direction of the S2 axis. Also, since FIG. 5 is planarly drawn, displacement of a point between before change and after change of the polarization state is indicated by a straight line arrow in the Figure, but in practice, the change of the polarization state due to passing through the liquid crystal layer or optically compensatory film is expressed, on the Poincare sphere, by the rotation at a specific angle around a specific axis determined according to the optical characteristics.

In FIG. 5, the point 1 indicates the polarization state of incident light and the point 2 indicates the polarization state of outgoing light. More specifically, the point A indicates the position on the Poincare sphere after passing the retardation film A (in the present invention, the protective film A), the point B indicates the position on the Poincare sphere after transmitting through the vertically aligned VA cell from the point A, and the point 2 indicates the position on the Poincare sphere after passing the retardation film B (in the present invention, the protective film B) from the point B.

If B, G and R light components of visible light are converging at the point 2 when light incident from the point 1 reaches the point 2 after passing through the protective film A, liquid crystal cell and protective film B, color shift does not occur. However, in practice, when Rth is a fixed value independent of the wavelength of light, the distance traveled by light transmitted through a material having birefringence differs among B, G and R light components, because the traveling distance depends on Rth/λ. By designing the protective film A such that Rth increases as the wavelength becomes larger, B, G and R light components can converge at the point A. In a normal VA-type liquid crystal cell, since Rth decreases as the wavelength becomes larger when the liquid crystal cell is in a vertically aligned state, light passed through the liquid crystal cell reaches near the point B but does not converge. By designing the protective film B to have wavelength dependency high enough to cancel the non-converging portion produced through the liquid crystal cell wavelength dependency, the light can be converged at the point 2 and the color shift can be reduced.

In the present invention, RthB(λ) of the protective film B has negative characteristics for the ambient temperature and satisfies the following formula (11): Formula (11):

−3.0≦(RthB(λ)(T)/RthB(λ)(25° C.))/(T−25)<0

(wherein RthB(λ)(T) indicates the Rth value at a wavelength of λ nm at T° C.).

It is more preferred to satisfy formula (11′): Formula (11′):

−2.5≦(RthB(λ)(T)/RthB(λ)(25° C.))/(T−25)<0

In the present invention, the protective film B is preferably provided between the polarizing plate provided on the front side and the liquid crystal cell. The protective film B undergoes fluctuation based on the ambient temperature and thereby exerts an effect of compensating for fluctuation of the liquid crystal cell when the liquid crystal display device is exposed to various embodiments.

The Re value and Rth value of the protective film can be adjusted, in the case of using a cellulose acylate film as the protective film, by the substitution degree of cellulose acylate, the kind or amount of retardation raising agent added to the cellulose acylate film, the drying temperature or time of cellulose acylate film, or the stretch ratio, stretching temperature or residual solvent amount at stretching of the cellulose acylate film. Preferred ranges of respective control factors and the controlling method are described below.

In the present invention, ReA(λ) and RthA(λ) of the protective film A disposed on the liquid crystal cell side of one polarizing plate of the liquid crystal display device each preferably increases as the wavelength becomes larger in the wavelength range of 400 to 700 nm.

In the following, the phenomenon where the refractive index or birefringence of an optical film fluctuates dependently of light in the visible region (that is, dependently of the measurement wavelength) is referred to as “wavelength dispersion property of refractive index or birefringence of an optical film”. In particular, when the optical film has a performance of increasing its refractive index or birefringence for light in the visible region dependently of the wavelength thereof, this is referred to as “have reverse wavelength dispersion property”, whereas when the optical film has a performance of decreasing its refractive index or birefringence for light in the visible region dependently of the wavelength thereof, this is referred to as “have forward wavelength dispersion property”.

As for the protective film A disposed on the liquid crystal cell side of one polarizing plate of the liquid crystal display device of the present invention, the polymer composition may also be subjected to orientation treatment such as stretching to give a reverse wavelength-dispersive birefringence (Δn) while assigning the positive direction to the orientation control direction (hereinafter referred to as a “TD direction”) by the stretching or the like.

Here, Δn is a value obtained by subtracting the refractive index in the MD direction from the refractive index in the TD direction. Accordingly, in order to obtain reverse wavelength-dispersive Δn, the wavelength dispersion property in the MD direction needs to surpass the wavelength dispersion property of the refractive index in the TD direction (that is, when the refractive index value in each direction based on the measurement wavelength is plotted from the short wavelength side on the left to the long wavelength side on the right, the decrease of refractive index in the MD direction is larger).

The wavelength dispersion property of the refractive index has a close relation to the absorption waveform of a substance as indicated by the Lorentz-Lorenz formula, and for allowing the wavelength dispersion property of the refractive index in the MD direction to surpass the wavelength dispersion property in the TD direction, this may be attained by making longer the absorption transition wavelength in the MD direction than that in the TD direction.

### [Retardation Controlling Agent A]

In the present invention, a compound such as compound (A) described below is added to a polymer material and furthermore, an orientation treatment such as stretching is applied thereto, whereby the absorption transition wavelength in the MD direction can be made longer than that in the TD direction.

That is, as for the compound (A), a compound having a property such that when the compound is added in a polymer material and a stretching treatment is applied thereto, the molecular long axis of the compound (A) is oriented in the TD direction, is selected. Furthermore, the compound (A) is suitably a compound where the molecular absorption wavelength derived from the electric dipole transition moment My in a direction nearly orthogonal to the molecular long axis direction is longer than the molecular absorption wavelength derived from the electric dipole transition moment Mx in a direction nearly parallel to the molecular long axis direction and the size |My| of the electric dipole transition moment in a direction nearly orthogonal to the molecular long axis is larger than the size |Mx| of the electric dipole transition moment in a direction nearly parallel to the molecular long axis direction. By the addition of the compound (A) having such properties, the absorption transition wavelength in the MD direction can be made longer than that in the TD direction.

The compound (A) is preferably a compound represented by the following formula (I) but is not limited thereto.

The compound of formula (I) is described in detail below:

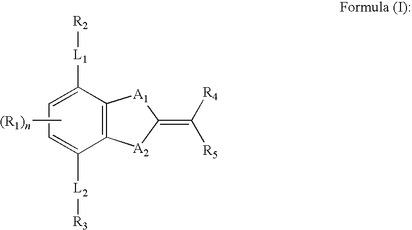

In formula (I), L₁ and L₂ each represents a single bond or a divalent linking group. A₁ and A₂ each is a group independently selected from —O—, —NR— (wherein R is a hydrogen atom or a substituent), —S— and —CO—. R₁, R₂, R₃, R₄ and R₅ each represents a substituent. n represents an integer of 0 to 2.

Preferred examples of L₁ and L₂ include the followings.

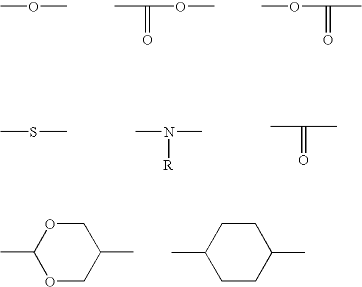

Among these, more preferred are —O—, —COO— and —OCO—.

R₁ is a substituent and when a plurality of the substituents are present, these may be the same or different or may form a ring. Examples of the applicable substituent include:

a halogen atom (e.g., fluorine, chlorine, bromine, iodine), an alkyl group (preferably an alkyl group having a carbon number of 1 to 30, e.g., methyl, ethyl, n-propyl, isopropyl, tert-butyl, n-octyl, 2-ethylhexyl), a cycloalkyl group (preferably a substituted or unsubstituted cycloalkyl group having a carbon number of 3 to 30, e.g., cyclohexyl, cyclopentyl, 4-n-dodecylcyclohexyl), a bicycloalkyl group (preferably a substituted or unsubstituted bicycloalkyl group having a carbon number of 5 to 30, that is, a monovalent group obtained by removing one hydrogen atom from a bicycloalkane having a carbon number of 5 to 30, e.g., bicyclo[1,2,2]heptan-2-yl, bicyclo[2,2,2]octan-3-yl), an alkenyl group (preferably a substituted or unsubstituted alkenyl group having a carbon number of 2 to 30, e.g., vinyl, allyl), a cycloalkenyl group (preferably a substituted or unsubstituted cycloalkenyl group having a carbon number of 3 to 30, that is, a monovalent group obtained by removing one hydrogen atom from a cycloalkene having a carbon number of 3 to 30, e.g., 2-cyclopenten-1-yl, 2-cyclohexen-1-yl), a bicycloalkenyl group (a substituted or unsubstituted bicycloalkenyl group, preferably a substituted or unsubstituted bicycloalkenyl group having a carbon number of 5 to 30, that is, a monovalent group obtained by removing one hydrogen atom from a bicycloalkene having one double bond, e.g., bicyclo[2,2,1]hept-2-en-1-yl, bicyclo[2,2,2]oct-2-en-4-yl), an alkynyl group (preferably a substituted or unsubstituted alkynyl group having a carbon number of 2 to 30, e.g., ethynyl, propargyl), an aryl group (preferably a substituted or unsubstituted aryl group having a carbon number of 6 to 30, e.g., phenyl, p-tolyl, naphthyl), a heterocyclic group (preferably a monovalent group obtained by removing one hydrogen atom from a 5- or 6-membered substituted or unsubstituted, aromatic or non-aromatic heterocyclic group, more preferably a 5- or 6-membered aromatic heterocyclic group having a carbon number of 3 to 30, e.g., 2-furyl, 2-thienyl, 2-pyrimidinyl, 2-benzothiazolyl), a cyano group, a hydroxyl group, a nitro group, a carboxyl group, an alkoxy group (preferably a substituted or unsubstituted alkoxy group having a carbon number of 1 to 30, e.g., methoxy, ethoxy, isopropoxy, tert-butoxy, n-octyloxy, 2-methoxyethoxy), an aryloxy group (preferably a substituted or unsubstituted aryloxy group having a carbon number of 6 to 30, e.g., phenoxy, 2-methylphenoxy, 4-tert-butylphenoxy, 3-nitrophenoxy, 2-tetradecanoylaminophenoxy), a silyloxy group (preferably a silyloxy group having a carbon number of 3 to 20, e.g., trimethylsilyloxy, tert-butyldimethylsilyloxy), a heterocyclic oxy group (preferably a substituted or unsubstituted heterocyclic oxy group having a carbon number of 2 to 30, e.g., 1-phenyltetrazol-5-oxy, 2-tetrahydropyranyloxy), an acyloxy group (preferably a formyloxy group, a substituted or unsubstituted alkylcarbonyloxy group having a carbon number of 2 to 30, and a substituted or unsubstituted arylcarbonyloxy group having a carbon number of 6 to 30, e.g., formyloxy, acetyloxy, pivaloyloxy, stearoyloxy, benzoyloxy, p-methoxyphenylcarbonyloxy), a carbamoyloxy group (preferably a substituted or unsubstituted carbamoyloxy group having a carbon number of 1 to 30, e.g., N,N-dimethylcarbamoyloxy, N,N-diethylcarbamoyloxy, morpholinocarbonyloxy, N,N-di-n-octylaminocarbonyloxy, N-n-octylcarbamoyloxy), an alkoxycarbonyloxy group (preferably a substituted or unsubstituted alkoxycarbonyloxy group having a carbon number of 2 to 30, e.g., methoxycarbonyloxy, ethoxycarbonyloxy, tert-butoxycarbonyloxy, n-octylcarbonyloxy), an aryloxycarbonyloxy group (preferably a substituted or unsubstituted aryloxycarbonyloxy group having a carbon number of 7 to 30, e.g., phenoxycarbonyloxy, p-methoxy-phenoxycarbonyloxy, p-n-hexadecyloxyphenoxycarbonyloxy), an amino group (preferably an amino group, a substituted or unsubstituted alkylamino group having a carbon number of 1 to 30, and a substituted or unsubstituted anilino group having a carbon number of 6 to 30, e.g., amino, methylamino, dimethylamino, anilino, N-methyl-anilino, diphenylamino), an acylamino group (preferably a formylamino group, a substituted or unsubstituted alkylcarbonylamino group having a carbon number of 2 to 30, and a substituted or unsubstituted arylcarbonylamino group having a carbon number of 6 to 30, e.g., formylamino, acetylamino, pivaloylamino, lauroylamino, benzoylamino), an aminocarbonylamino group (preferably a substituted or unsubstituted aminocarbonylamino group having a carbon number of 1 to 30, e.g., carbamoylamino, N,N-dimethylaminocarbonylamino, N,N-diethylaminocarbonylamino, morpholinocarbonylamino), an alkoxycarbonylamino group (preferably a substituted or unsubstituted alkoxycarbonylamino group having a carbon number of 2 to 30, e.g., methoxycarbonylamino, ethoxycarbonylamino, tert-butoxycarbonylamino, n-octadecyloxycarbonylamino, N-methyl-methoxycarbonylamino), an aryloxycarbonylamino group (preferably a substituted or unsubstituted aryloxycarbonylamino group having a carbon number of 7 to 30, e.g., phenoxycarbonylamino, p-chlorophenoxycarbonylamino, m-n-octyloxyphenoxycarbonylamino), a sulfamoylamino group (preferably a substituted or unsubstituted sulfamoylamino group having a carbon number of 0 to 30, e.g., sulfamoylamino, N,N-dimethylaminosulfonylamino, N-n-octylaminosulfonylamino), an alkyl- or aryl-sulfonylamino group (preferably a substituted or unsubstituted alkylsulfonylamino group having a carbon number of 1 to 30, and a substituted or unsubstituted arylsulfonylamino group having a carbon number of 6 to 30, e.g., methylsulfonylamino, butylsulfonylamino, phenylsulfonylamino, 2,3,5-trichlorophenylsulfonylamino, p-methylphenylsulfonylamino), a mercapto group, an alkylthio group (preferably a substituted or unsubstituted alkylthio group having a carbon number of 1 to 30, e.g., methylthio, ethylthio, n-hexadecylthio), an arylthio group (preferably a substituted or unsubstituted arylthio group having a carbon number of 6 to 30, e.g., phenylthio, p-chlorophenylthio, m-methoxy-phenylthio), a heterocyclic thio group (preferably a substituted or unsubstituted heterocyclic thio group having a carbon number of 2 to 30, e.g., 2-benzothiazolylthio, 1-phenyltetrazol-5-ylthio), a sulfamoyl group (preferably a substituted or unsubstituted sulfamoyl group having a carbon number of 0 to 30, e.g., N-ethylsulfamoyl, N-(3-dodecyloxypropyl)sulfamoyl, N,N-dimethylsulfamoyl, N-acetylsulfamoyl, N-benzoylsulfamoyl, N-(N′-phenyl-carbamoyl)sulfamoyl), a sulfo group, an alkyl- or aryl-sulfinyl group (preferably a substituted or unsubstituted alkylsulfinyl group having a carbon number of 1 to 30, and a substituted or unsubstituted arylsulfinyl group having a carbon number of 6 to 30, e.g., methylsulfinyl, ethylsulfinyl, phenylsulfinyl, p-methylphenylsulfinyl), an alkyl- or aryl-sulfonyl group (preferably a substituted or unsubstituted alkylsulfonyl group having a carbon number of 1 to 30, and a substituted or unsubstituted arylsulfonyl group having a carbon number of 6 to 30, e.g., methylsulfonyl, ethylsulfonyl, phenylsulfonyl, p-methylphenylsulfonyl), an acyl group preferably a formyl group, a substituted or unsubstituted alkylcarbonyl group having a carbon number of 2 to 30, and a substituted or unsubstituted arylcarbonyl group having a carbon number of 7 to 30, e.g., acetyl, pivaloylbenzoyl), an aryloxycarbonyl group (preferably a substituted or unsubstituted aryloxycarbonyl group having a carbon number of 7 to 30, e.g., phenoxycarbonyl, o-chlorophenoxycarbonyl, m-nitrophenoxycarbonyl, p-tert-butylphenoxycarbonyl), an alkoxycarbonyl group (preferably a substituted or unsubstituted alkoxycarbonyl group having a carbon number of 2 to 30, e.g., methoxycarbonyl, ethoxycarbonyl, tert-butoxycarbonyl, n-octadecyloxycarbonyl), a carbamoyl group (preferably a substituted or unsubstituted carbamoyl group having a carbon number of 1 to 30, e.g., carbamoyl, N-methylcarbamoyl, N,N-dimethylcarbamoyl, N,N-di-n-octylcarbamoyl, N-(methylsulfonyl)carbamoyl), an aryl- or heterocyclic-azo group (preferably a substituted or unsubstituted arylazo group having a carbon number of 6 to 30, and a substituted or unsubstituted heterocyclic azo group having a carbon number of 3 to 30, e.g., phenylazo, p-chlorophenylazo, 5-ethylthio-1,3,4-thiadiazol-2-ylazo), an imido group (preferably an N-succinimido group and an N-phthalimido group), a phosphino group (preferably a substituted or unsubstituted phosphino group having a carbon number of 2 to 30, e.g., dimethylphosphino, diphenylphosphino, methylphenoxyphosphino), a phosphinyl group (preferably a substituted or unsubstituted phosphinyl group having a carbon number of 2 to 30, e.g., phosphinyl, dioctyloxyphosphinyl, diethoxyphosphinyl), a phosphinyloxy group (preferably a substituted or unsubstituted phosphinyloxy group having a carbon number of 2 to 30, e.g., diphenoxyphosphinyloxy, dioctyloxyphosphinyloxy), a phosphinylamino group (preferably a substituted or unsubstituted phosphinylamino group having a carbon number of 2 to 30, e.g., dimethoxyphosphinylamino, dimethylaminophosphinylamino), and a silyl group (preferably a substituted or unsubstituted silyl group having a carbon number of 3 to 30, e.g., trimethylsilyl, tert-butyldimethylsilyl, phenyldimethylsilyl).

Out of the above-described substituents, those having a hydrogen atom may be deprived of the hydrogen atom and be further substituted by a group above. Examples of such a functional group include an alkylcarbonylaminosulfonyl group, an arylcarbonylaminosulfonyl group, an alkyl-sulfonylaminocarbonyl group and an arylsulfonylaminocarbonyl group. Examples thereof include a methylsulfonyl-aminocarbonyl group, a p-methylphenylsulfonylaminocarbonyl group, an acetylaminosulfonyl group and a benzoylaminosulfonyl group.

R₁ is preferably a halogen atom, an alkyl group, an alkenyl group, an aryl group, a heterocyclic group, a hydroxyl group, a carboxyl group, an alkoxy group, an aryloxy group, an acyloxy group, a cyano group or an amino group, more preferably a halogen atom, an alkyl group, a cyano group or an alkoxy group.

R₂ and R₃ each independently represents a substituent. Examples thereof include those of R₁ described above. The substituent is preferably a substituted or unsubstituted benzene ring or a substituted or unsubstituted cyclohexane ring, more preferably a benzene ring having a substituent or a cyclohexane ring having a substituent, still more preferably a benzene ring having a substituent at the 4-position or a cyclohexane ring having a substituent at the 4-position.

R₄ and R₅ each independently represents a substituent. Examples thereof include those of R₁ described above. The substituent is preferably an electron-withdrawing substituent having a Hammett's substituent constant σₚ value of more than zero, more preferably an electron-withdrawing substituent having a σₚ value of 0 to 1.5. Examples of such a substituent include a trifluoromethyl group, a cyano group, a carbonyl group and a nitro group. R₄ and R₅ may combine together to form a ring.

Here, the Hammett's substituent constants σₚ and σₘ are described in detail, for example, in Naoki Inamoto, Hammett Soku—Kozo to Hannousei—(Hammett's Rule—Structure and Reactivity—), Maruzen; Shin-Jikken Kagaku Koza 14, Yuki Kagobutsu no Gosei to Hanno V (New Experimental Chemistry Course 14, Synthesis and Reaction V of Organic Compound), page 2605, edited by The Chemical Society of Japan, Maruzen; Tadao Nakaya, Riron Yuki Kagaku Kaisetsu (Theoretical Organic Chemistry Handbook), page 217, Tokyo Kagaku Dojin; and Chemical Review, Vol. 91, pp. 165-195 (1991).

A₁ and A₂ each is a group independently selected from —O—, —NR—(wherein R is a hydrogen atom or a substituent), —S— and —CO—, preferably a group independently selected from —O—, —NR— (wherein R is a substituent) and —S—.

n is preferably 0 or 1, and most preferably 0.

As regards the compound represented by formula (I), which is preferably contained in the protective film of the present invention, particularly in the protective film A, Compounds (1) to (169) described in [0056] to [0063] of JP-A-2007-249180 may be used. These compounds can be synthesized according to the synthesis schemes described in [0064] to [0067] of the same patent publication.

In the present invention, the content of the compound (A) or compound represented by formula (I) is preferably from 0.1 to 30 parts by mass, more preferably from 0.5 to 20 parts by mass, still more preferably from 1 to 12 parts by mass, and most preferably from 1 to 5 parts by mass, based on the cellulose compound.

The compound (A) or compound represented by formula (I) preferably exhibits liquid crystallinity in a temperature range from 100 to 300° C., more preferably from 120 to 200° C. The liquid crystal phase is preferably a nematic phase or a smectic phase.

### (Retardation Controlling Agent B)

In addition to the (controlling agent A), the preferred retardation raising agent includes those comprising a rod-like compound having at least two aromatic rings.

The rod-like compound for use in the present invention is a compound where a plurality of aromatic rings are linearly linked (a compound having a linear molecular structure). The term “linear molecular structure” means that the molecular structure of the rod-like compound is linear in a thermodynamically most stable configuration. The thermodynamically most stable configuration can be determined by the crystal structure analysis or molecular orbital calculation. For example, the molecular orbital calculation is performed using a software program for molecular orbital calculation (e.g., WinMOPAC2000, produced by Fujitsu Ltd.), whereby a molecular structure capable of minimizing the heat of formation of the compound can be determined. The expression “the molecular structure is linear” means that the angle of the molecular structure is 140° or more in the thermodynamically most stable configuration determined by calculation as above.

The rod-like compound preferably exhibits liquid crystallinity. The rod-like compound more preferably exhibits liquid crystallinity when heated (has thermotropic liquid crystallinity). The liquid crystal phase is preferably a nematic phase or a smectic phase.

The rod-like compound is preferably represented by the following formula (I):

Ar¹-L¹-Ar² (I)

In formula (I), Ar¹ and Ar² each is independently an aromatic group.

The aromatic group contains the above-described aromatic hydrocarbon ring or aromatic heterocyclic ring as the aromatic ring. Substituents of the aromatic group are the same as the above-described substituents of the aromatic ring.

In formula (1), L¹ is a divalent linking group selected from the group consisting of an alkylene group, an alkenylene group, an alkynylene group, a divalent saturated heterocyclic group, —O—, —CO— and a combination thereof.

The alkylene group may have a cyclic structure. The cyclic alkylene group is preferably a cyclohexylene, more preferably a 1,4-cyclohexylene. The chain alkylene group is preferably a linear alkylene rather than a branched alkylene group.

The number of carbon atoms in the alkylene group is preferably from 1 to 20, more preferably from 1 to 15, still more preferably from 1 to 10, yet still more preferably from 1 to 8, and most preferably from 1 to 6.

The alkenylene group and alkynylene group each preferably has a chain structure rather than a cyclic structure, more preferably a linear structure rather than a branched chain structure.

The number of carbon atoms in the alkenylene group and alkynylene group is preferably from 2 to 10, more preferably from 2 to 8, still more preferably from 2 to 6, yet still more preferably from 2 to 4, and most preferably 2 (vinylene or ethynylene).

The divalent saturated heterocyclic group preferably has a 3- to 9-membered heterocyclic ring. The heteroatom in the heterocyclic group is preferably an oxygen atom, a nitrogen atom, a boron atom, a sulfur atom, a silicon atom, a phosphorus atom or a germanium atom. Examples of the saturated heterocyclic ring include a piperidine ring, a piperazine ring, a morpholine ring, a pyrrolidine ring, an imidazolidine ring, a tetrahydrofuran ring, a tetrahydropyran ring, a 1,3-dioxane ring, a 1,4-dioxane ring, a tetrahydrothiophene ring, a 1,3-thiazolidine ring, a 1,3-oxazolidine ring, 1,3-dioxolan ring, 1,3-dithiolane ring and a 1,3,2-dioxaborane. Above all, preferred divalent saturated heterocyclic groups are piperazine-1,4-diylene, 1,3-dioxane-2,5-diylene and 1,3,2-dioxaborane-2,5-diylene.

Examples of the divalent linking group comprising a combination are set forth below.
L-1: —O—CO-alkylene group-CO—O—
L-2: —CO—O-alkylene group-O—CO—
L-3: —O—CO-alkenylene group-CO—O—
L-4: —CO—O-alkenylene group-O—CO—
L-5: —O—CO-alkynylene group-CO—O—
L-6: —CO—O-alkynylene group-O—CO—
L-7: —O—CO-divalent saturated heterocyclic group-CO—O—
L-8: —CO—O-divalent saturated heterocyclic group-O—CO—

In the molecular structure of formula (I), the angle formed by Ar¹ and Ar² across L¹ is 140° or more.

The rod-like compound is more preferably represented by the following formula (II):

Ar¹-L²-X-L³-Ar² Formula (II):

In formula (II), Ar¹ and Ar² each is independently an aromatic group.

The aromatic group has the above-described aromatic hydrocarbon ring or aromatic heterocyclic ring as the aromatic ring. Substituents of the aromatic group are the same as the above-described substituents of the aromatic ring.

In formula (II), L² and L³ each is independently a divalent linking group selected from the group consisting of an alkylene group, —O—, —CO— and a combination thereof.

The alkylene group preferably has a chain structure rather than a cyclic structure, more preferably a linear structure rather than a branched chain structure.

The number of carbon atoms in the alkylene group is preferably from 1 to 10, more preferably from 1 to 8, still more preferably from 1 to 6, yet still more preferably from 1 to 4, and most preferably 1 or 2 (methylene or ethylene).

In particular, L² and L³ is preferably —O—CO— or —CO—O—.

In formula (II), X is a 1,4-cyclohexylene, a vinylene or an ethynylene.

As for the rod-like aromatic compound represented by formula (I), Compounds (1) to (53) described in [0040] to [0051] of JP-A-2004-50516, and trans- and cis-forms thereof may be used.

As described above, the rod-like aromatic compound used as the retardation raising agent preferably has a liner molecular structure. Accordingly, a trans-form is preferred rather than a cis-form.

Compounds (2) and (3) described in [0040] of JP-A-2004-50516 each has optical isomers (four isomers in total), in addition to geometrical isomers. As for the geometrical isomer, a trans-form is preferred rather than a cis-form. The optical isomers have no specific difference in the superiority and may be a D-form, an L-form or a racemic form.

In Compounds (43) to (45) described in [0048] of the patent publication above, the vinylene bond at the center includes a trans-from and a cis-form. For the same reason as above, a trans-form is preferred rather than a cis-form.

### (Controlling Agent C)

As to the retardation raising agent for use in the present invention, a compound represented by the following formula (II) is also preferred.

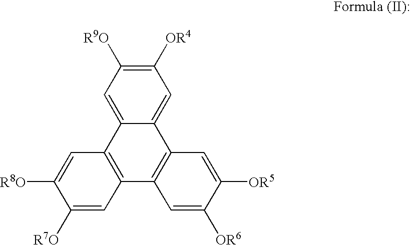

In formula (II), R⁴, R⁵, R⁶, R⁷, R⁸ and R⁹ each independently represents a hydrogen atom or a substituent.

Examples of the substituent represented by each of R⁴, R⁵, R⁶, R⁷, R⁸ and R⁹ include an alkyl group (preferably an alkyl group having a carbon number of 1 to 40, more preferably from 1 to 30, still more preferably from 1 to 20, e.g., methyl, ethyl, isopropyl, tert-butyl, n-octyl, n-decyl, n-hexadecyl, cyclopropyl, cyclopentyl, cyclohexyl), an alkenyl group (preferably an alkenyl group having a carbon number of 2 to 40, more preferably from 2 to 30, still more preferably from 2 to 20, e.g., vinyl, allyl, 2-butenyl, 3-pentenyl), an alkynyl group (preferably an alkynyl group having a carbon number of 2 to 40, more preferably from 2 to 30, still more preferably from 2 to 20, e.g., propargyl, 3-pentynyl), an aryl group (preferably an aryl group having a carbon number of 6 to 30, more preferably from 6 to 20, still more preferably from 6 to 12, e.g., phenyl, p-methylphenyl, naphthyl), a substituted or unsubstituted amino group (preferably an amino group having a carbon number of 0 to 40, more preferably from 0 to 30, still more preferably from 0 to 20, e.g., unsubstituted amino, methylamino, dimethylamino, diethylamino, anilino), an alkoxy group (preferably an alkoxy group having a carbon number of 1 to 40, more preferably from 1 to 30, still more preferably from 1 to 20, e.g., methoxy, ethoxy, butoxy), an aryloxy group (preferably an aryloxy group having a carbon number of 6 to 40, more preferably from 6 to 30, still more preferably from 6 to 20, e.g., phenyloxy, 2-naphthyloxy), an acyl group (preferably an acyl group having a carbon number of 1 to 40, more preferably from 1 to 30, still more preferably from 1 to 20, e.g., acetyl, benzoyl, formyl, pivaloyl), an alkoxycarbonyl group (preferably an alkoxycarbonyl group having a carbon number of 2 to 40, more preferably from 2 to 30, still more preferably from 2 to 20, e.g., methoxycarbonyl, ethoxycarbonyl), an aryloxycarbonyl group (preferably an aryloxycarbonyl group having a carbon number of 7 to 40, more preferably from 7 to 30, still more preferably from 7 to 20, e.g., phenyloxycarbonyl), an acyloxy group (preferably an acyloxy group having a carbon number of 2 to 40, more preferably from 2 to 30, still more preferably from 2 to 20, e.g., acetoxy, benzoyloxy), an acylamino group (preferably an acylamino group having a carbon number of 2 to 40, more preferably from 2 to 30, still more preferably from 2 to 20, e.g., acetylamino, benzoylamino), an alkoxycarbonylamino group (preferably an alkoxycarbonylamino group having a carbon number of 2 to 40, more preferably from 2 to 30, still more preferably from 2 to 20, e.g., methoxycarbonylamino), an aryloxycarbonylamino group (preferably an aryloxycarbonylamino group having a carbon number of 7 to 40, more preferably from 7 to 30, still more preferably from 7 to 20, e.g., phenyloxycarbonylamino), a sulfonylamino group (preferably a sulfonylamino group having a carbon number of 1 to 40, more preferably from 1 to 30, still more preferably from 1 to 20, e.g., methanesulfonylamino, benzenesulfonylamino), a sulfamoyl group (preferably a sulfamoyl group having a carbon number of 0 to 40, more preferably from 0 to 30, still more preferably from 0 to 20, e.g., sulfamoyl, methylsulfamoyl, dimethylsulfamoyl, phenylsulfamoyl), a carbamoyl group (preferably a carbamoyl group having a carbon number of 1 to 40, more preferably from 1 to 30, still more preferably from 1 to 20, e.g., unsubstituted carbamoyl, methylcarbamoyl, diethylcarbamoyl, phenylcarbamoyl), an alkylthio group (preferably an alkylthio group having a carbon number of 1 to 40, more preferably from 1 to 30, still more preferably from 1 to 20, e.g., phenylthio), a sulfonyl group (preferably a sulfonyl group having a carbon number of 1 to 40, more preferably from 1 to 30, still more preferably from 1 to 20, e.g., mesyl, tosyl), a sulfinyl group (preferably a sulfinyl group having a carbon number of 1 to 40, more preferably from 1 to 30, still more preferably from 1 to 20, e.g., methanesulfinyl, benzenesulfinyl), a ureido group (preferably a ureido group having a carbon number of 1 to 40, more preferably from 1 to 30, still more preferably from 1 to 20, e.g., unsubstituted ureido, methylureido, phenylureido), a phosphoric acid amide group (preferably a phosphoric acid amide group having a carbon number of 1 to 40, more preferably from 1 to 30, still more preferably from 1 to 20, e.g., diethylphosphoric acid amide, phenylphosphoric acid amide), a hydroxy group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group, an imino group, a heterocyclic group (preferably a heterocyclic group having a carbon number of 1 to 30, more preferably from 1 to 12, for example, a heterocyclic group having a heteroatom such as nitrogen atom, oxygen atom and sulfur atom, e.g., imidazolyl, pyridyl, quinolyl, furyl, piperidyl, morpholino, benzoxazolyl, benzimidazolyl, benzothiazolyl, 1,3,5-triazyl), and a silyl group (preferably a silyl group having a carbon number of 3 to 40, more preferably from 3 to 30, still more preferably from 3 to 24, e.g., trimethylsilyl, triphenylsilyl). These substituents each may be further substituted by such a substituent. Also, when two or more substituents are present, the substituents may be the same or different and, if possible, may combine together to form a ring.

The substituent represented by R⁴, R⁵, R⁶, R⁷, R⁸ and R⁹ is preferably an alkyl group, an aryl group, a substituted or unsubstituted amino group, an alkoxy group, an aryloxy group or a halogen atom.

Specific examples of the compound represented by formula (TI) include the compounds described in paragraphs [0122] and [0123] of JP-A-2007-249180.

### (Controlling Agent D)

As to the retardation raising agent for use in the present invention, a compound represented by the following formula (III) is also preferred.

The compound represented by formula (III) is described below.

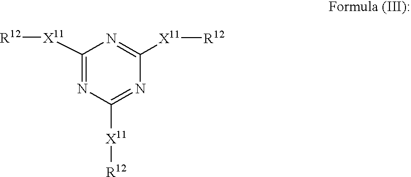

In formula (III), each R¹² independently represents an aromatic or heterocyclic ring having a substituent at least at any one of the ortho-, meta- and para-positions.

Each X¹¹ independently represents a single bond or —NR¹³—, wherein each R¹³ independently represents a hydrogen atom, a substituted or unsubstituted alkyl group, an alkenyl group, an aryl group or a heterocyclic group.

The aromatic ring represented by R¹² is preferably phenyl or naphthyl, more preferably phenyl. The aromatic ring represented by R¹² may have at least one substituent at any substitution site. Examples of the substituent include a halogen atom, hydroxyl, cyano, nitro, carboxyl, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamido group, carbamoyl, an alkyl-substituted carbamoyl group, an alkenyl-substituted carbamoyl group, an aryl-substituted carbamoyl group, an amido group, an alkylthio group, an alkenylthio group, an arylthio group, and an acyl group.

The heterocyclic group represented by R¹² preferably has aromaticity. The heterocyclic ring having aromaticity is generally an unsaturated heterocyclic ring, preferably a heterocyclic ring having a maximum number of double bonds. The heterocyclic ring is preferably a 5-membered ring, a 6-membered ring or a 7-membered ring, more preferably a 5-membered ring or a 6-membered ring, and most preferably a 6-membered ring. The heteroatom of the heterocyclic ring is preferably a nitrogen atom, a sulfur atom or an oxygen atom, more preferably a nitrogen atom. In particular, the heterocyclic ring having aromaticity is preferably a pyridine ring (as a heterocyclic group, 2-pyridyl or 4-pyridyl). The heterocyclic group may have a substituent. Examples of the substituent of the heterocyclic group are the same as the above-described examples of the substituent for the aryl moiety.

The heterocyclic group when X¹¹ is a single bond is preferably a heterocyclic group having a free valence on a nitrogen atom. The heterocyclic group having a free valence on a nitrogen atom is preferably a 5-membered ring, a 6-membered ring or a 7-membered ring, more preferably a 5-membered ring or a 6-membered ring, and most preferably a 5-membered ring. The heterocyclic group may have a plurality of nitrogen atoms. Also, the heterocyclic group may have a heteroatom (e.g., O, S) other than a nitrogen atom. Examples of the heterocyclic group having a free valence on a nitrogen atom are set forth below.

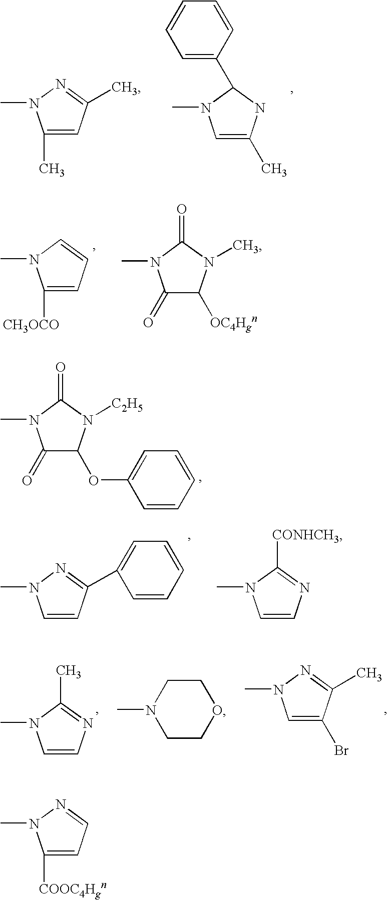

In Formula (III), X¹¹ represents a single bond or —NR¹³—. R¹³ independently represents a hydrogen atom or a substituted or unsubstituted alkyl, alkenyl, aryl or heterocyclic group.

The alkyl group represented by R¹³ may be a cyclic alkyl group or a chain alkyl group but is preferably a chain alkyl group and preferably a linear alkyl group rather than a branched chain alkyl group. The number of carbon atoms in the alkyl group is preferably from 1 to 30, more preferably from 1 to 20, still more preferably from 1 to 10, yet still more preferably from 1 to 8, and most preferably from 1 to 6. The alkyl group may have a substituent. Examples of the substituent include a halogen atom, an alkoxy group (e.g., methoxy, ethoxy) and an acyloxy group (e.g., acryloyloxy, methacryloyloxy).

The alkenyl group represented by R¹³ may be a cyclic alkenyl group or a chain alkenyl group but is preferably a chain alkenyl group and preferably a linear alkenyl group rather than a branched chain alkenyl group. The number of carbon atoms in the alkenyl group is preferably from 2 to 30, more preferably from 2 to 20, still more preferably from 2 to 10, yet still more preferably from 2 to 8, and most preferably from 2 to 6. The alkenyl group may have a substituent. Examples of the substituent are the same as those of the substituent for the alkyl group above.

The aromatic ring group and heterocyclic group represented by R¹³ are the same as the aromatic ring and heterocyclic ring represented by R¹², and their preferred ranges are also the same. The aromatic ring group and heterocyclic group each may further have a substituent, and examples of the substituent are the same as those of the substituent for the alkyl group above.

Specific examples of the retardation raising agent represented by formula (III) for use in the present invention include the compounds described in paragraphs [0097] to [0113] of JP-A-2007-249180.

The retardation raising agent for use in the present invention is preferably the above-described retardation controlling agents (A) to (D), and one of these compounds may be used alone, or some may be mixed and used.

The protective film A for use in the present invention contains at least one member selected from the retardation controlling agents (A), (B) and (D), and another kind of a compound may be used in combination. The controlling agent (C) may be added, if desired. The preferred combination of controlling agents for obtaining a protective film A having objective Re and Rth with these retardation values being higher as the wavelength is longer is a combination of controlling agents (A) and (B) or a combination of controlling agents (A) and (D).

The protective film B for use in the present invention contains at least one member selected from the retardation controlling agents (A) to (D), and another kind of a compound may be used in combination. For obtaining a protective film B having objective Re and Rth with these retardation values being lower as the wavelength is longer, it is preferred to use controlling agent (C) or (D), and controlling agents (C) and (D) may be used in combination. Furthermore, for controlling the temperature dependency of Rth of the protective film B, at least one member selected from the controlling agents (A) and (B) is preferably added and used in addition to the controlling agents (C) and (D), and at this time, it is more preferred to use the controlling agents (A) and (B) in combination.

The amount added of each of the retardation controlling agents (A) to (D) for use in the present invention is preferably from 0.1 to 20 mass %, more preferably from 0.5 to 15 mass %, still more preferably from 0.5 to 10 mass %, based on the substrate polymer of the protective film. The total amount added of the retardation controlling agents (A) to (D) is preferably from 0.1 to 30 mass %, more preferably from 0.5 to 25 mass %, still more preferably from 0.5 to 20 mass %, based on the substrate polymer of the protective film.

Also, the amount of the controlling agent (A) added to the protective film A is preferably from 0.1 to 20 mass %, more preferably from 0.5 to 15 mass %, still more preferably from 0.5 to 10 mass %, based on the substrate polymer, and the amount in total of the controlling agents (B) to (D) is preferably from 0.1 to 30 mass %, more preferably from 0.5 to 25 mass %, still more preferably from 0.5 to 20 mass %.

The amount of the controlling agent (C) added to the protective film B is preferably from 0.1 to 15 mass %, more preferably from 0.1 to 10 mass %, still more preferably from 0.1 to 5 mass %, based on the substrate polymer, and the amount in total of the controlling agents (A), (B) and (D) is preferably from 0.1 to 30 mass %, more preferably from 0.5 to 25 mass %, still more preferably from 0.5 to 20 mass %.

The protective film A for use in the present invention is a film of the substrate polymer containing the above-described retardation controlling agent, that is, a cellulose acylate film. For obtaining the objective Re and Rth and causing these retardation values to be higher as the wavelength is longer, in addition to selection of these retardation controlling agents and optimization of the amount added, the process conditions for producing the film need to be adjusted. In particular, the retardation values can be adjusted by the stretching conditions described below. Also, for adjusting the wavelength dependency of the retardation value, it is necessary to control the orientation of cellulose molecular chains and control the orientation of the retardation controlling agent, and the wavelength dependency can be adjusted by controlling the drying rate or drying temperature of the film in the steps after casting the cellulose composition dope, the residual solvent amount at the stretching, or the like.

The protective film B for use in the present invention is a film of the substrate polymer containing the above-described retardation controlling agent, that is, a cellulose acylate film. For obtaining the objective Re and Rth and causing the Rth value to be higher as the wavelength is shorter, in addition to selection of these retardation controlling agents and optimization of the amount added, the process conditions for producing the film need to be adjusted. In particular, the retardation values can be adjusted by the stretching conditions described below. Also, for adjusting the wavelength dependency of the retardation value, it is necessary to control the orientation of cellulose molecular chains and control the orientation of the retardation controlling agent, and the wavelength dependency can be adjusted by controlling the drying rate or drying temperature of the film in the steps after casting the cellulose composition dope, the residual solvent amount at the stretching, or the like. Also, for controlling the temperature dependency of Rth of the protective film B, it is effective to use a retardation controlling agent capable of changing the orientation in the cellulose with respect to the ambient temperature. In particular, in order to impart negative temperature dependency to Rth, the orientation in the film thickness direction of the retardation controlling agent needs to be decreased as the temperature rises. Specific examples of the technique therefor include a method where a compound that exhibits liquid crystallinity in the cellulose is used as the retardation controlling agent.

The cellulose acylate for use in the present invention is described in detail below.

In the present invention, two or more different kinds of cellulose acylates may be mixed and used. In the case where the cellulose acylate film is a protective film disposed on the liquid crystal cell side of the polarizing plate, assuming that the substitution degree by an acyl group for the hydroxyl group at the 2-position of the glucose unit constituting the cellulose is DS2, the substitution degree by an acyl group for the hydroxyl group at the 3-position is DS3 and the substitution degree by an acyl group for the hydroxyl group at the 6-position is DS6, the cellulose acylate film preferably satisfies the following formulae (vi) and (vii):

2.0≦DS2+DS3+DS6≦3.0 Formula (vi):

DS6/(DS2+DS3+DS6)≧0.315 Formula (vii):

By satisfying formulae (vi) and (vii), solubility in a solvent can be enhanced and the humidity dependence of optical anisotropy can be reduced.

As the total of DS2+DS3+DS6 is smaller, the optical anisotropy developing property is higher but the humidity-dependent change of optical anisotropy becomes larger, giving rise to a problem in practical use. Conversely, when the total of DS2+DS3+DS6 is large, the humidity-dependent change of optical anisotropy is small but the optical anisotropy developing property becomes low. Accordingly, in order to satisfy the optical anisotropy in terms of both the developing property and humidity-dependent change, the total of DS2+DS3+DS6 is preferably from 2.2 to 2.9, more preferably from 2.4 to 2.85.

Furthermore, in order to suppress the humidity-dependent change without impairing the optical anisotropy developing property, DS6/(DS2+DS3+DS6) is preferably 0.315 or more, more preferably 0.318 or more.

In the present invention, for the protective film B provided on the viewing side of the liquid crystal cell, it is particularly preferred to satisfy formulae (vi) and (vii).

The specific cellulose acylate is a mixed fatty acid ester of a cellulose obtained by substituting the hydroxyl groups of a cellulose by an acetyl group and an acyl group having a carbon number of 3 or more, and this may be a cellulose acylate where the substitution degrees to the hydroxyl groups of a cellulose satisfy the following formulae (viii) and (xiv):

2.0≦A+B≦3.0 Formula (viii):

0<B Formula (xiv):

In formulae, A and B each represents the substitution degree of an acyl group substituted to a hydroxyl group of a cellulose, A is a substitution degree of an acetyl group, and B is a substitution degree of an acyl group having a carbon number of 3 or more.

The β-1,4-bonded glucose unit constituting a cellulose has a free hydroxyl group at the 2-position, 3-position and 6-position. The cellulose acylate is a polymer where these hydroxyl groups are partially or entirely esterified by an acyl group. The acyl substitution degree means a ratio of esterification of the cellulose at each of the 2-position, 3-position and 6-position (100% esterification is a substitution degree of 1).

In the present invention, the sum total (A+B) of the substitution degrees A and B to hydroxyl groups is from 2.0 to 3.0 as shown in mathematical formula (viii), preferably from 2.2 to 2.9, more preferably from 2.40 to 2.85. The substitution degree B is preferably a value exceeding 0 as shown in mathematical formula (xiv), more preferably 0.6 or more.

If A+B is less than 2.0, hydrophilicity is intensified and the film becomes susceptible to the ambient humidity.

The substituent of the 6-position hydroxyl group preferably occupies 28% or more of B, more preferably 30% or more, still more preferably 31% or more, and in particular, 32% or more is preferably the substituent of the 6-position hydroxyl group.

The sum of substitution degrees of A and B at the 6-position of the cellulose acylate is preferably 0.75 or more, more preferably 0.80 or more, still more preferably 0.85 or more. By virtue of such a cellulose acylate film, a solution for film preparation can be produced with preferred filterability, and a good solution can be produced even in a chlorine-free organic solvent. Furthermore, a solution with low viscosity and good filterability can be prepared.

The acyl group (B) having a carbon number of 3 or more may be an aliphatic group or an aromatic hydrocarbon group and is not particularly limited. Examples thereof include an alkylcarbonyl ester of cellulose, an alkenylcarbonyl ester of cellulose, an aromatic carbonyl ester of cellulose and an aromatic alkylcarbonyl ester of cellulose, which each may have a group substituted thereto. Preferred examples of B include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group and a cinnamoyl group. Among these group, preferred are a propionyl group, a butanoyl group, a dodecanoyl group, a octadecanoyl group, a tert-butanoyl group, an oleoyl group, a benzoyl group, a naphthylcarbonyl group and a cinnamoyl group, more preferred are a propionyl group and a butanoyl group. In the case of a propionyl group, the substitution degree B is preferably 1.3 or more.

Specific examples of the mixed fatty acid cellulose acylate include cellulose acetate propionate and cellulose acetate butyrate.

### (Synthesis Method of Cellulose Acylate)

The fundamental principle of the synthesis method for a cellulose acylate is described in Migita et al., Mokuzai Kagaku (Wood Chemistry), pp. 180-190, Kyoritsu Shuppan (1968). A representative synthesis method is a liquid phase-acetylation method using a system of carboxylic acid anhydride-acetic acid-sulfuric acid catalyst.

For obtaining the above-described cellulose acylate, specifically, a cellulose raw material such as cotton linter and wood pulp is pretreated with an appropriate amount of acetic acid, charged into a previously cooled carboxylation mixture and esterified to synthesize a complete cellulose acylate (the total acyl substitution degree at 2-, 3- and 6-positions is almost 3.00). The carboxylation mixture generally contains an acetic acid as the solvent, a carboxylic acid anhydride as the esterifying agent, and a sulfuric acid as the catalyst. The carboxylic acid anhydride is usually used in a stoichiometrically excess amount with respect to the total of a cellulose that reacts therewith and water present in the system. After the completion of esterification reaction, an aqueous solution of a neutralizing agent (for example, a carbonate, acetate or oxide of calcium, magnesium, iron, aluminum or zinc) is added to hydrolyze the excess carboxylic acid anhydride remaining in the system and neutralize a part of the esterification catalyst. The complete cellulose acylate obtained is kept at 50 to 90° C. in the presence of a small amount of an acetylation catalyst (generally, the remaining sulfuric acid) to effect saponification ripening until the cellulose acylate changes into a cellulose acylate having desired acyl substitution degree and polymerization degree. At the point where the desired cellulose acylate is obtained, the catalyst remaining in the system may be completely neutralized using the above-described neutralizing agent or may not be neutralized, and thereafter, a cellulose acylate is separated by pouring the cellulose acylate solution in water or dilute sulfuric acid (alternatively, by pouring water or dilute sulfuric acid in the cellulose acylate solution) and then subjected to washing and stabilization, whereby the specific cellulose acylate can be obtained.

In the cellulose acylate film, the polymer component constituting the film is preferably composed of substantially the above-described specific cellulose acylate. The “substantially” means to account for 55 mass % or more (preferably 70 mass % or more, more preferably 80 mass % or more) of the polymer component.

The cellulose acylate is preferably used in a particle form. Also, 90 mass % or more of the particle used preferably has a particle diameter of 0.5 to 5 mm, and 50 mass % or more of the particle used preferably has a particle diameter of 1 to 4 mm. The cellulose acylate particle preferably has a shape as close to sphere as possible.

The polymerization degree of the cellulose acylate preferably used in the present invention is, in terms of the viscosity average polymerization degree, preferably from 200 to 700, more preferably from 250 to 550, still more preferably from 250 to 400, yet still more preferably from 250 to 350. The average polymerization degree can be measured according to the intrinsic viscosity method proposed by Uda et al. (Kazuo Uda and Hideo Saito, Journal of the Society of Fiber Science and Technology, Japan, Vol. 18, No. 1, pp. 105-120 (1962)). This is also described in detail in JP-A-9-95538.

As for the cellulose acylate, a cellulose acylate from which low molecular components are removed is useful, because when low molecular components are removed, the average molecular weight (polymerization degree) rises, but the viscosity becomes lower than that of normal cellulose acylate. A cellulose acylate having a small content of low molecular components can be obtained by removing low molecular components from a cellulose acylate synthesized by a normal method. The low molecular components can be removed by washing the cellulose acylate with an appropriate organic solvent. Incidentally, in the case of producing a cellulose acylate having a small content of low molecular components, the amount of the sulfuric acid catalyst in the acetylation reaction is preferably adjusted to 0.5 to 25 parts by mass per 100 parts by mass of the cellulose acylate. When the amount of the sulfuric acid catalyst is adjusted to this range, a cellulose acylate advantageous also in view of molecular weight distribution (uniform molecular weight distribution) can be synthesized. In use at the production of a cellulose acylate, the moisture content is preferably 2 mass % or less, more preferably 1 mass % or less, still more preferably 0.7 mass % or less. In general, a cellulose acylate contains moisture and is known to have a moisture content of 2.5 to 5 mass %. In the present invention, in order to obtain this moisture content, the cellulose acylate needs to be dried and the method therefor is not particularly restricted as long as the objective moisture content can be obtained.

As for the raw material cotton and synthesis method of the cellulose acylate, the raw material cottons and synthesis methods described in detail in JIII Journal of Technical Disclosure, No. 2001-1745, pp. 7-12, Japan Institute of Invention and Innovation (Mar. 15, 2001) may be employed.

The cellulose acylate film of the present invention can be obtained by dissolving the above-described specific cellulose acylate and, if desired, additives in an organic solvent and forming a film from the resulting solution.

### (Additives)

In the present invention, examples of the additive which can be used in the above-described cellulose acylate solution include a plasticizer, an ultraviolet absorbent, a deterioration inhibitor, a dye, a retardation (optical anisotropy) raising agent, a retardation (optical anisotropy) decreasing agent, a fine particle, a separation accelerator and an infrared absorbent. In the present invention, a retardation raising agent is preferably used. Also, at least one or more members of a plasticizer, an ultraviolet absorbent, a separation accelerator and a dye are preferably used.

These additives may be a solid or an oily product. That is, the additive is not particularly limited in its melting point or boiling point. For example, a mixture of ultraviolet absorbents having a melting point of 20° C. or less and a melting point of 20° C. or more may be used. Similarly, a mixture of plasticizers may be used. These are described, for example, in JP-A-2001-151901.

Any kind of an ultraviolet absorbent may be freely selected according to the purpose and, for example, a salicylic acid ester-based, benzophenone-based, benzotriazole-based, benzoate-based, cyanoacrylate-based or nickel complex salt-based absorbent may be used. The absorbent is preferably a benzophenone-based, benzotriazole-based or salicylic acid ester-based absorbent. Examples of the benzophenone-based ultraviolet absorbent include 2,4-dihydroxybenzophenone, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone. Examples of the benzotriazole-based ultraviolet absorbent include 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole, 2-(2′-hydroxy-3′,5′-di-tert-butylphenyl)-5-chlorobenzotriazole and 2-(2′-hydroxy-5′-tert-octylphenyl)benzotriazole. Examples of the salicylic acid ester-based ultraviolet absorbent include phenyl salicylate, p-octylphenyl salicylate and p-tert-butylphenyl salicylate. Among these ultraviolet absorbents, preferred are 2-hydroxy-4-methoxybenzophenone, 2,2′-dihydroxy-4,4′-methoxybenzophenone, 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole and 2-(2′-hydroxy-3′,5′-di-tert-butylphenyl)-5-chlorobenzotriazole.

As for the ultraviolet absorbent, a plurality of absorbents differing in the absorption wavelength are preferably used in combination, because a high shielding effect can be obtained over a wide wavelength range. The ultraviolet absorbent for liquid crystal is preferably an absorbent that exhibits excellent capability of absorbing ultraviolet light at a wavelength of 370 nm or less from the standpoint of preventing deterioration of the liquid crystal and absorbs less visible light at a wavelength 400 nm or more in view of liquid crystal display property. In particular, the ultraviolet absorbent is preferably the above-described benzotriazole-based compound, benzophenone-based compound or salicylic acid ester-based compound. Above all, the benzotriazole-based compound is preferred because of less occurrence of unnecessary coloration for the cellulose ester.

The compounds described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173 may also be used as the ultraviolet absorbent.

The amount of the ultraviolet absorbent added is preferably from 0.001 to 5 mass %, more preferably from 0.01 to 1 mass %, based on the cellulose acylate. If the amount added is less than 0.001 mass %, the effects obtainable by the addition cannot be fully brought out, whereas if the amount added exceeds 5 mass %, the ultraviolet absorbent sometimes bleeds out to the film surface.

The ultraviolet absorbent may be added simultaneously at the time of dissolving the cellulose acylate or may be added to the dope after the dissolution. In particular, a form of adding an ultraviolet absorbent solution to the dope immediately before casting by using a static mixer or the like is preferred, because the spectral absorption properties can be easily adjusted.

As for the deterioration inhibitor, the compounds described in [0199] of JP-A-2007-249180 may be used; as for the plasticizer, the compounds described in [0200] of the same patent publication may be used; and as for the separation accelerator, the compounds described in [0201] of the same patent publication may be used. Also, the timing or form of adding such a compound may follow the descriptions in [0202] to [0205] of the same patent publication.

In the cellulose acylate film of the present invention, a fine particle is preferably added as a matting agent. As for the fine particle used in the present invention, the compounds described in [0211] to [0217] of JP-A-2007-249180 may be used. The method for dispersing or adding the particle, the amount added of the particle and the solvent used for dispersion may follow the descriptions in [0218] to [0219] of the same patent publication.

As for the organic solvent in which the cellulose acylate of the present invention is dissolved, chlorine-based solvents and other organic solvents which can be used in combination with a chlorine-based solvent are described in [0220] to [0224] of JP-A-2007-249180, and these solvents may be used. Examples of the combination of a chlorine-based organic solvent with other organic solvents include, but are not limited to, the following compositions:

dichloromethane/methanol/ethanol/butanol (80/10/5/5, parts by mass), dichloromethane/acetone/methanol/propanol (80/10/5/5, parts by mass), dichloromethane/methanol/butanol/cyclohexane (80/10/5/5, parts by mass), dichloromethane/methyl ethyl ketone/methanol/butanol (80/10/5/5, parts by mass), dichloromethane/acetone/methyl ethyl ketone/ethanol/isopropanol (75/8/5/5/7, parts by mass), dichloromethane/cyclopentanone/methanol/isopropanol (80/7/5/8, parts by mass), dichloromethane/methyl acetate/butanol (80/10/10, parts by mass), dichloromethane/cyclohexanone/methanol/hexane (70/20/5/5, parts by mass), dichloromethane/methyl ethyl ketone/acetone/methanol/ethanol (50/20/20/5/5, parts by mass), dichloromethane/1,3-dioxolan/methanol/ethanol (70/20/5/5, parts by mass), dichloromethane/dioxane/acetone/methanol/ethanol (60/20/10/5/5, parts by mass), dichloromethane/acetone/cyclopentanone/ethanol/iso-butanol/cyclohexane (65/10/10/5/5/5, parts by mass), dichloromethane/methyl ethyl ketone/acetone/methanol/ethanol (70/10/10/5/5, parts by mass), dichloromethane/acetone/ethyl acetate/ethanol/butanol/hexane (65/10/10/5/5/5, parts by mass), dichloromethane/methyl acetoacetate/methanol/ethanol (65/20/10/5, parts by mass) and dichloromethane/cyclopentanone/ethanol/butanol (65/20/10/5, parts by mass).

### (Chlorine-Free Solvent)

As for the chlorine-free organic solvent that is preferably used at the preparation of a solution of the cellulose acylate of the present invention, chlorine-free solvents, other organic solvents which can be used in combination with a chlorine-free solvent, and the mixing ratio therebetween are described in [0226] to [0232] of JP-A-2007-249180, and these solvents may be used.

Preferred examples of the combination of chlorine-free organic solvents for use in the present invention are set forth below, but the combination is not limited thereto:

methyl acetate/acetone/methanol/ethanol/butanol (75/10/5/5/5, parts by mass), methyl acetate/acetone/methanol/ethanol/propanol (75/10/5/5/5, parts by mass), methyl acetate/acetone/methanol/butanol/cyclohexane (75/10/5/5/5, parts by mass), methyl acetate/acetone/ethanol/butanol (81/8/7/4, parts by mass), methyl acetate/acetone/ethanol/butanol (82/10/4/4, parts by mass), methyl acetate/acetone/ethanol/butanol (80/10/4/6, parts by mass), methyl acetate/methyl ethyl ketone/methanol/butanol (80/10/5/5, parts by mass), methyl acetate/acetone/methyl ethyl ketone/ethanol/isopropanol (75/8/10/5/7, parts by mass), methyl acetate/cyclopentanone/methanol/isopropanol (80/7/5/8, parts by mass), methyl acetate/acetone/butanol (85/10/5, parts by mass), methyl acetate/cyclopentanone/acetone/methanol/butanol (60/15/14/5/6, parts by mass), methyl acetate/cyclohexanone/methanol/hexane (70/20/5/5, parts by mass), methyl acetate/methyl ethyl ketone/acetone/methanol/ethanol (50/20/20/5/5, parts by mass), methyl acetate/1,3-dioxolan/methanol/ethanol (70/20/5/5, parts by mass), methyl acetate/dioxane/acetone/methanol/ethanol (60/20/10/5/5, parts by mass), methyl acetate/acetone/cyclopentanone/ethanol/isobutanol/cyclohexane (65/10/10/5/5/5, parts by mass), methyl formate/methyl ethyl ketone/acetone/methanol/ethanol (50/20/20/5/5, parts by mass), methyl formate/acetone/ethyl acetate/ethanol/butanol/hexane (65/10/10/5/5/5, parts by mass), acetone/methyl acetoacetate/methanol/ethanol (65/20/10/5, parts by mass), acetone/cyclopentanone/ethanol/butanol (65/20/10/5, parts by mass), acetone/1,3-dioxolan/ethanol/butanol (65/20/10/5, parts by mass), and 1,3-dioxolan/cyclohexanone/methyl ethyl ketone/methanol/butanol (55/20/10/5/5/5, parts by mass).

Furthermore, a cellulose acylate solution prepared by the following method may also be used:

a method of preparing a cellulose acylate solution from methyl acetate/acetone/ethanol/butanol (81/8/7/4, parts by mass), filtering and concentrating the solution and then additionally adding 2 parts by mass of butanol;

a method of preparing a cellulose acylate solution from methyl acetate/acetone/ethanol/butanol (84/10/4/2, parts by mass), filtering and concentrating the solution and then additionally adding 4 parts by mass of butanol; and

a method of preparing a cellulose acylate solution from methyl acetate/acetone/ethanol (84/10/6, parts by mass), filtering and concentrating the solution and then additionally adding 5 parts by mass of butanol.

In addition to the above-described chlorine-free organic solvent of the present invention, the dope for use in the present invention may contain dichloromethane in an amount of 10 mass % or less based on the entire amount of organic solvents of the present invention.

### (Properties of Cellulose Acylate Solution)

In view of suitability for film formation by casting, the cellulose acylate solution is preferably a solution prepared by dissolving the cellulose acylate in the above-described organic solvent to a concentration of 10 to 30 mass %, more preferably from 13 to 27 mass %, still more preferably from 15 to 25 mass %. As to the method for adjusting the cellulose acylate concentration to such a range, the concentration may be adjusted to a predetermined concentration at the stage of dissolving the cellulose acylate, or the solution may be previously prepared as a low-concentration (for example, from 9 to 14 mass %) solution and thereafter formed into a solution having a predetermined high concentration in the concentrating step described later. Furthermore, a high-concentration cellulose acylate solution may be previously prepared and thereafter formed into a cellulose acylate solution having a predetermined low concentration by adding various additives. These methods all may be used without problem as long as the cellulose acylate solution concentration of the present invention can be obtained.

In the present invention, from the standpoint of dissolution in a solvent, when the cellulose acylate solution is diluted to a concentration of 0.1 to 5 mass % by an organic solvent having the same composition, the aggregate molecular weight of cellulose acylate in the resulting diluted solution is preferably from 150,000 to 15,000,000, more preferably from 180,000 to 9,000,000. The aggregate molecular weight can be determined by a static light scattering method. The cellulose acylate is preferably dissolved such that the squared radius of inertia simultaneously determined by this method becomes from 10 to 200 nm. The squared radius of inertia is more preferably from 20 to 200 nm. Also, the cellulose acylate is preferably dissolved such that the second virial coefficient becomes from −2×10⁻⁴ to +4×10⁻⁴. The second virial coefficient is more preferably from −2×10⁻⁴ to +2×10⁻⁴.

The definitions of aggregate molecular weight, squared radius of inertia and second virial coefficient as used in the present invention are described below. These are measured using a static light scattering process according to the following method. For the convenience's sake of apparatus, the measurement is performed in the dilute region, but these measured values reflect the behavior of dope in the high-concentration region of the present invention.

First, solutions of 0.1 mass %, 0.2 mass %, 0.3 mass % or 0.4 mass % are prepared by dissolving the cellulose acylate in a solvent which is used for the dope. Here, in order to prevent absorption of moisture, cellulose acylate dried at 120° C. for 2 hours is used and weighed at 25° C. and 10% RH. The dissolution is performed by the method employed at the dissolution of dope (ordinary temperature dissolution, cooling dissolution or high temperature dissolution). Subsequently, these solutions with solvent are filtered through a 0.2-μm Teflon (registered trademark)-made filter, and static light scattering of each filtered solution is measured at 25° C. by using a light scattering spectrophotometer (DLS-700, manufactured by Otsuka Electronics Co., Ltd.) in 10° steps from 30° to 140°. The obtained data are analyzed by the BERRY plotting method. A value of the solvent determined by an Abbe refractometer is used as the refractive index required in this analysis, and the concentration gradient (dn/dc) of refractive index is measured by using a differential refractometer (DRM-1021, manufactured by Otsuka Electronics Co., Ltd.) and using the solvent and solution used in the measurement of light scattering.

### (Preparation of Dope)

The preparation of the cellulose acylate solution (dope) is described below. The method for dissolving the cellulose acylate is not particularly limited, and the dissolution may be performed at room temperature or by using a cooling dissolution method, a high temperature dissolution method or a combination thereof. With respect to these dissolution methods, the preparation method of a cellulose acylate solution is described, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388. The method for dissolving a cellulose acylate in an organic solvent described in these techniques can be appropriately applied also in the present invention as long as it is within the scope of the present invention. In particular, as for the chlorine-free solvent system, the method described in detail in JIII Journal of Technical Disclosure, No. 2001-1745, pp. 22-25, Japan Institute of Invention and Innovation (Mar. 15, 2001) can be employed. Furthermore, the dope solution of the cellulose acylate for use in the present invention is usually subjected to concentrating and filtration of the solution, and these are also described in detail in JIII Journal of Technical Disclosure, No. 2001-1745, page 25, Japan Institute of Invention and Innovation (Mar. 15, 2001). In the case of dissolving the cellulose acylate at a high temperature, the temperature is most often higher than the boiling point of the organic solvent used and in such a case, a system under applied pressure is used.

In the cellulose acylate solution, the viscosity and dynamic storage modulus of the solution are preferably in the following ranges, because casting is facilitated. A sample solution (1 mL) is measured using Steel Cone with a diameter of 4 cm/2° of Rheometer (CLS 500) (both manufactured by TA Instruments). The measurement is performed under the conditions of Oscillation Step and Temperature Ramp by varying the temperature at 2° C./min in the range from 40° C. to −10° C., and the static non-Newton viscosity n* (Pa·s) at 40° C. and storage modulus G′ (Pa) at −5° C. are determined. Incidentally, the measurement is started after previously keeping the sample solution at the measurement initiation temperature until the liquid temperature becomes constant. In the present invention, the cellulose acylate solution preferably has a viscosity of 1 to 400 Pa·s at 40° C. and a dynamic storage modulus of 500 Pa or more at 15° C., more preferably a viscosity of 10 to 200 Pa·s at 40° C. and a dynamic storage modulus of 100 to 1,000,000 Pa at 15° C. Furthermore, the dynamic storage modulus at low temperatures is preferably larger and, for example, when the casting support is at −5° C., the dynamic storage modulus at −5° C. is preferably from 10,000 to 1,000,000 Pa, and when the support is at −50° C., the dynamic storage modulus at −50° C. is preferably from 10,000 to 5,000,000 Pa.

In the present invention, the above-described specific cellulose acylate is used and therefore, a high-concentration dope is characteristically obtained, so that a high-concentration cellulose acylate solution with excellent stability can be obtained even without relying on the concentrating means. In order to more facilitate the dissolution, after dissolving the cellulose acylate to a low concentration, the solution may be concentrated by using the concentrating means. The method for concentrating the solution is not particularly limited but, for example, the solution can be concentrated by a method of introducing a low-concentration solution between a cylindrical body and a rotation trajectory of the outer circumference of a rotary blade rotating in the circumferential direction inside the cylindrical body and at the same time, creating a temperature difference between the cylindrical body and the solution to obtain a high-concentration solution while evaporating the solvent (see, for example, JP-A-4-259511); or a method of injecting a heated low-concentration solution into a vessel from a nozzle, flash-evaporating the solvent during traveling of the solution from the nozzle until reaching the inner wall of vessel, and extracting the solvent vapor from the vessel while extracting a high-concentration solution from the vessel bottom (see, for example, U.S. Pat. Nos. 2,541,012, 2,858,229, 4,414,341 and 4,504,355).

In advance of casting, the solution is preferably subjected to filtration through an appropriate filter medium such as metal mesh or flannel to remove undissolved materials or foreign matters such as dust and impurity. For the filtration of the cellulose acylate solution, a filter having an absolute filtration precision of 0.1 to 100 μm is preferably used, and a filter having an absolute filtration precision of 0.5 to 25 μm is more preferably used. The thickness of the filter is preferably from 0.1 to 10 mm, more preferably from 0.2 to 2 mm. In this case, the filtration pressure is preferably 1.6 MPa or less, more preferably 1.2 MPa or less, still more preferably 1.0 MPa or less, yet still more preferably 0.2 MPa or less. As for the filter medium, a conventionally known material such as glass fiber, cellulose fiber, filter paper and fluororesin (e.g., ethylene tetrafluoride resin) may be preferably used. In particular, ceramic, metal and the like are preferred. The viscosity of the cellulose acylate solution immediately before film formation may be sufficient if the solution can be cast at the film formation. Usually, the solution is preferably prepared to have a viscosity of 10 to 2,000 Pa1·s, more preferably from 30 to 1,000 Pa·s, still more preferably from 40 to 500 Pa·s. At this time, the temperature is not particularly limited as long as it is a temperature at the casting, but the temperature is preferably from −5 to +70° C., more preferably from −5 to +55° C.

### (Film Formation)

The cellulose acylate film of the present invention can be obtained by film-forming the above-described cellulose acylate solution. As for the method and apparatus for film formation, the solution casting film formation method and the solution casting film formation apparatus conventionally used for the production of a cellulose triacetate film are used. A dope (cellulose acylate solution) prepared in a dissolver (pot) is once stored in a storage pot for removing bubbles contained in the dope and is used for final preparation. The dope is supplied to a pressure die from a dope exit through, for example, a pressure-type quantitative gear pump capable of constant-rate feeding with high precision by the number of rotations and uniformly cast on a metal support in a casting part endlessly running from a mouth ring (slit) of the pressure die, and a semi-dried dope film (also called a web) is peeled off from the metal support at a peeling point after nearly one round of the metal support. The obtained web is pinched with clips at both ends, transported in a tenter while keeping the width, thereby dried, subsequently transported by a roll group of a drying apparatus to complete the drying, and then taken up to a predetermined length by a take-up machine. The combination of the tenter and the drying apparatus having a roll group varies depending on the purpose. In the solution casting film formation method used for a functional protective film of electronic displays, in addition to the solution casting film formation apparatus, a coating apparatus is added in many cases so as to apply surface treatment to the film, such as subbing layer, antistatic layer, antihalation layer and protective layer. Each production step is simply described below, but the present invention is not limited thereto.

In producing a cellulose acylate film by a solvent cast method, the prepared cellulose acylate solution (dope) is cast on a drum or a band and the solvent is evaporated to form a film. The dope before casting is preferably adjusted to a concentration of giving a solid content amount of 5 to 40 mass %. The surface of the drum or band is preferably finished to provide a mirror state. The dope is preferably cast on a drum or band having a surface temperature of 30° C. or less. In particular, the surface temperature is preferably a metal support temperature of -10 to 20° C. Furthermore, the methods described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650 may be used in the present invention.

### (Multilayer Casting)

The cellulose acylate solution may be cast in the form of a single-layer solution on a smooth band or drum working as a metal support, or a plurality of cellulose acylate solutions for two or more layers may be cast. In the case of casting a plurality of cellulose acylate solutions, respective cellulose acylate-containing solutions may be cast from a plurality of casting ports provided with spacing in the travelling direction of the metal support to produce a film while stacking one on another and, for example, the methods described in JP-A-61-158414, JP-A-1-122419 and JP-A-11-198285 may be applied. Also, cellulose acylate solutions may be cast from two casting ports to effect film formation and this can be practiced by the method described, for example, in JP-B-60-27562 (the term “JP-B” as used herein means an “examined Japanese patent publication”), JP-A-61-94724, JP-A-61-947245, JP-A-61-104813, JP-A-61-158413 and JP-A-6-134933. In addition, a cellulose acylate film casting method described in JP-A-56-162617 of encompassing the flow of a high-viscosity cellulose acylate solution with a low-viscosity cellulose acylate solution and simultaneously extruding the high-viscosity and low-viscosity cellulose acylate solutions may be used. A method of incorporating a larger amount of an alcohol component as a poor solvent into the solution on the outer side than into the solution on the inner side described in JP-A-61-94724 and JP-A-61-94725 is also a preferred embodiment. Furthermore, the film can also be produced using two casting ports by separating a film cast from a first casting port and formed on a metal support and performing a second casting on the side that had been in contact with the metal support surface, and this method is described, for example, in JP-B-44-20235. The cellulose acylate solutions cast may be the same or different and are not particularly limited. In order to impart a function to a plurality of cellulose acylate layers, a cellulose acylate solution according to the function may be extruded from each casting port. The cellulose acylate solution may also be cast simultaneously with other functional layers (for example, adhesive layer, dye layer, antistatic layer, antihalation layer, UV absorbing layer and polarizing layer).

Many of conventional single-layer solutions have a problem that a high-viscosity cellulose acylate solution in a high concentration must be extruded so as to obtain a required film thickness and in this case, the cellulose acylate solution has bad stability to produce a solid material, giving rise to particle failure or poor planarity. For solving this problem, when a plurality of cellulose acylate solutions are cast from casting ports, high-viscosity solutions can be simultaneously extruded on the metal support and not only the planarity can be improved to allow for production of a film having excellent surface state but also reduction in the drying load can be achieved by virtue of use of a thick cellulose acylate solution to thereby raise the production speed of the film. In the case of co-casting, the layers on the inner and outer sides are not particularly limited in the thickness but the thickness on the outer side preferably occupies from 1 to 50%, more preferably from 2 to 30%, of the entire film thickness. Here, in the case of co-casting of three or more layers, the total thickness of the layer in contact with the metal support and the layer in contact with the air side is defined as the thickness on the outer side. In the case of co-casting, a cellulose acylate film having a laminate structure may also be produced by co-casting cellulose acylate solutions differing in the concentration of the above-described additive such as plasticizer, ultraviolet absorbent and matting agent. For example, a cellulose acylate film having a construction of skin layer/core layer/skin layer can be produced. In this case, for example, the matting agent may be incorporated in a larger amount into the skin layer or may be incorporated only into the skin layer. The plasticizer and ultraviolet absorbent each may be incorporated in a larger amount into the core layer than into the skin layer or may be incorporated only into the core layer. The plasticizer and ultraviolet absorbent each may be changed in the kind between the core layer and the skin layer and, for example, at least either one of a low-volatile plasticizer and a low-volatile ultraviolet absorbent may be incorporated into the skin layer, while adding a plasticizer with excellent plasticity or an ultraviolet absorbent with excellent ultraviolet absorptivity to the core layer. It is also a preferred embodiment to incorporate a separation accelerator only into the skin layer on the metal support side. In addition, an alcohol as a poor solvent may be added in a larger amount into the skin layer than into the core layer so as to gel the solution by cooling the metal support according to a cooling drum method, and this is preferred. The Tg may differ between the skin layer and the core layer, and the Tg of the core layer is preferably lower than the Tg of the skin layer. The viscosity of the cellulose acylate-containing solution at the casting may also be different between the skin layer and the core layer, and the viscosity of the skin layer is preferably lower than the viscosity of the core layer, but the viscosity of the core layer may be lower than the viscosity of the skin layer.

### (Casting)

Examples of the method for casting the solution include a method of uniformly extruding a prepared dope on a metal support from a pressure die, a doctor blade method of controlling the thickness of a dope once cast on a metal support by using a blade, and a reverse roll coater method of controlling the thickness by using a roll rotating in reverse. A method using a pressure die is preferred. The pressure die includes a coat hanger die, a T-die and the like, and any of these can be preferably used. Other than the methods described above, conventionally known various methods for casting and film-forming a cellulose triacetate solution may be employed, and the same effects as those described in each patent publication can be obtained by setting respective conditions while taking into account the difference in the boiling point or the like of the solvent used. The endlessly running metal support used in the production of the cellulose acylate film of the present invention is a drum with the surface being mirror-finished by chromium plating or a stainless steel belt (may also be called a band) mirror-finished by surface polishing. As for the pressure die used in the production of the cellulose acylate film of the present invention, one unit or two or more units may be provided above the metal support. The pressure die provided is preferably one or two unit(s). In the case of providing two or more units, the amount of the dope cast may be divided into respective dies at various ratios, or the dope may be supplied to the dies at respective ratios by a plurality of precision quantitative gear pumps. The temperature of the cellulose acylate solution used for casting is preferably from −10 to 55° C., more preferably from 25 to 50° C. In this case, the temperature may be the same in all steps or may differ among respective portions in the process. When the temperature differs, it may sufficient if the temperature immediately before casting is a desired temperature.

### (Drying)

In the production of the cellulose acylate film, the dope on the metal support may be generally dried, for example, by a method of blowing hot air from the surface side of the metal support (drum or belt), that is, from the surface of the web on the metal support; a method of blowing hot air from the back surface of the drum or belt; or a liquid heat transfer method of bringing a liquid at a controlled temperature into contact with the drum or belt from the back surface opposite the dope casting surface and heating the drum or belt through heat transfer, thereby controlling the surface temperature. The back surface liquid heat transfer method is preferred. The metal support surface before casting may be at any temperature as long as it is lower than the boiling point of the solvent used for the dope. However, in order to accelerate the drying or deprive the solution of its fluidity on the metal support, the surface temperature is preferably set to a temperature 1 to 10° C. lower than the boiling point of the solvent having a lowest boiling point out of the solvents used. Incidentally, this does not apply to the case where the cast dope is cooled and peeled off without drying it.

The Re value and Rth value of the cellulose acylate film can be adjusted also by controlling the temperature of the metal support having cast thereon the dope film, or the temperature or volume of drying air blown to the dope film cast on the metal support. In particular, the Rth value is greatly affected by the drying conditions on the metal support. The Rth value is made low by raising the temperature of the metal support, raising the temperature of drying air blown to the dope film or raising the volume of drying air, that is, by increasing the quantity of heat applied to the dope film, whereas Rth is made high by decreasing the quantity of heat. In particular, drying in the first half from immediately after casting until stripping of the film greatly affects the Rth value.

### (Stretching Treatment)

The cellulose acylate film of the present invention can be stretched to adjust the retardation. A method of aggressively stretching the film in the width direction is also known and is described, for example, in JP-A-62-115035, JP-A-4-152125, JP-A-4-284211, JP-A-4-298310 and JP-A-11-48271. In this method, the produced film is stretched so as to make high the in-plane retardation value of the cellulose acylate film.

The stretching of film is performed at ordinary temperature or under heating condition. The heating temperature is preferably from the apparent glass transition temperature Tg of the film at stretching to Tg+20° C. The stretching of the film may be uniaxial stretching only in the longitudinal or transverse direction or may be simultaneous or successive biaxial stretching. The longitudinal stretching is performed at a stretch ratio of 0.1 to 50%, preferably from 1 to 10%, more preferably from 2 to 5%, and the transverse stretching is performed at a stretch ratio of 3 to 100%, preferably from 10 to 50%, more preferably from 20 to 40%. The birefringence of the film is preferably such that the refractive index in the width direction is larger than the refractive index in the length direction. Accordingly, the stretch ratio in the transverse stretching is preferably larger than the stretch ratio in the longitudinal stretching. The stretching may be performed on the way of film-formation step or the stock film produced and taken up may be stretched. In the former case, the film may be stretched in a state containing a residual solvent amount, and the film can be preferably stretched with a residual solvent amount of 2 to 40%.

In order to reduce the fluctuation of the in-plane slow axis with respect to the width direction, a relaxing step is preferably provided after transverse stretching. In the relaxing step, the width of the film after relaxation is preferably adjusted to 100 to 70% (relaxation percentage of 0 to 30%) based on the film width before relaxation. The temperature in the relaxing step is preferably from (apparent glass transition temperature Tg of film −10° C.) to (Tg+20° C.). Also, the residual solvent amount in the relaxing step is preferably from 2 to 20%.

Here, the apparent Tg of the film in the stretching step is determined by sealing a residual solvent-containing film in an aluminum pan, raising the temperature from 25° to 150° C. at 20° C./min by a differential scanning calorimeter (DSC), and obtaining an endothermic curve.

The thickness of the cellulose acylate film of the present invention obtained after drying varies depending on the intended use but usually, is preferably from 5 to 500 μm, more preferably from 20 to 300 μm, still more preferably from 30 to 150 μm. In the case of optical use, particularly use for VA liquid crystal display devices, the film thickness is preferably from 40 to 110 μm. The film thickness may be adjusted to a desired thickness by controlling, for example, the concentration of solid contents contained in the dope, the slit gap of die mouth ring, the extrusion pressure from die, or the speed of metal support. The thus-obtained cellulose acylate film preferably has a width of 0.5 to 3 m, more preferably from 0.6 to 2.5 m, still more preferably from 0.8 to 2.2 m. The length of the film taken up is preferably from 100 to 10,000 m, more preferably from 500 to 7,000 m, still more preferably from 1,000 to 6,000 m, per roll. At the time of taking up the film, knurling is preferably provided to at least one edge. The width thereof is preferably from 3 to 50 mm, more preferably from 5 to 30 mm, and the height is preferably from 0.5 to 500 μm, more preferably from 1 to 200 μm. The knurling may be either one-sided pressing or double-sided pressing.

In the present invention, Re(λ) and Rth(λ) indicate the in-plane retardation and the retardation in the thickness direction, respectively, at a wavelength of λ. Re(λ) is measured by making light at a wavelength of λ nm to be incident in the film normal direction in KOBRA WR (manufactured by Oji Scientific Instruments). Also, a retardation value is measured by making light at a wavelength of λ nm to be incident while varying the incident angle with respect to the film normal direction in 10° steps from −50° to +50° with the film normal direction being at an incident angle of 0° and the inclination axis (rotation axis) being the in-plane slow axis (judged by KOBRA WR), and based on the retardation value measured, assumed value of average refractive index and film thickness value input, Rth(λ) is calculated by KOBRA WR. In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA WR calculates nx, ny and nz and from these calculated nx, ny and nz, Nz=(nx−nz)/(nx−ny) is further calculated.

The fluctuation of the Re(590) value in full width is preferably ±5 nm, more preferably ±3 nm. Also, the fluctuation of the Rth(590) is preferably ±10 nm, more preferably ±5 nm. Furthermore, the fluctuations of the Re value and Rth value in the length direction are also preferably in respective fluctuation ranges for the width direction.

In the cellulose acylate film of the present invention, the fluctuation of the slow-axis angle in the film plane is preferably from −2° to +2°, more preferably from −1° to +1°, and most preferably −0.5° to +0.5°, with respect to the reference direction of the roll film. The reference direction as used herein indicates the longitudinal direction of the roll film when longitudinally stretching the cellulose acylate film and indicates the width direction of the roll film when transversely stretching the film.

In the cellulose acylate film of the present invention, from the standpoint of less allowing a liquid crystal display device to cause tint change due to aging, it is preferred that the difference ΔRe (=Re10% RH−Re80% RH) between the Re value at 25° C.-10% RH and the Re value at 25° C.-80% RH is from 0 to 10 nm and the difference ΔRth (=Rth10% RH−Rth80% RH) between the Rth value at 25° C.-10% RH and the Rth value at 25° C.-80% RH is from 0 to 30 nm.

Also, in the cellulose acylate film of the present invention, from the standpoint of less allowing a liquid crystal display device to cause tint change due to aging, the equilibrium moisture content at 25° C.-80% RH is preferably 3.2% or less.

In determining the moisture content, a sample (7 mm×35 mm) of the cellulose acylate film of the present invention is measured according to the Karl Fischer's method by using a water content measuring meter and a sample drying apparatus (CA-03 and VA-05, both manufactured by Mitsubishi Chemical Corporation). The moisture content is calculated by dividing the amount (g) of water by the mass (g) of the sample.

Furthermore, in the cellulose acylate film of the present invention, from the standpoint of less allowing a liquid crystal display device to cause tint change due to aging, the moisture permeability (in terms of moisture permeability with a film thickness of 80 μm) at 60° C.-95% RH for 24 hours is preferably from 400 to 1,800 g/m^{2·24} hr.

The moisture permeability becomes small when the thickness of the cellulose acylate film is large, and becomes large when the film thickness is small. Accordingly, whatever thickness the sample has, the value needs to be converted by setting a reference film thickness to 80 μm. The film thickness is converted according to “moisture permeability in terms of 80 μm=actually measured moisture permeability×actually measured film thickness μm/80 μm”.

As for the measurement method of the moisture permeability, the methods described in “Measurement of Amount of Water Vapor Permeated (mass method, thermometer method, water vapor pressure method, adsorption amount method)” of Kobunshi Jikken Koza 4, Kobunshi no Bussei II (Experimental Polymer Course 4, Physical Properties II of Polymers), pp. 285-294, Kyoritsu Shuppan, can be applied.

In the measurement of glass transition temperature, a sample (unstretched) (5 mm×30 mm) of the cellulose acylate film of the present invention is moisture-conditioned at 25° C.-60% RH for 2 hours or more and then measured by a dynamic viscoelasticity meter (Bibron DVA-225 (manufactured by IT Keisoku Seigyo K.K.)) under the conditions of a gripping distance of 20 mm, a temperature rising rate of 2° C./min, a measurement temperature range of 30 to 200° C. and a frequency of 1 Hz. The storage modulus is taken as a logarithmic axis on the ordinate, the temperature (° C.) is taken as a linear axis on the abscissa, and a straight line 1 in the solid region and a straight line 2 in the glass transition region are drawn to determine the abrupt decrease of the storage modulus which is observed when the storage modulus transfers from the solid region to the glass transition region. The intersection of straight line 1 and straight line 2 is the temperature where the storage modulus abruptly decreases at the temperature rise and the film starts softening, and this is a temperature allowing the start of transfer to the glass transition region and is defined as the glass transition temperature Tg (dynamic viscoelasticity).

In the measurement of the modulus of elasticity, a sample (10 mm×150 mm) of the cellulose acylate film of the present invention is moisture-conditioned at 25° C.-60% RH for 2 hours or more and then measured by a tensile tester (Strography R2 (manufactured by Toyo Seiki Seisaku-Sho, Ltd.)) under the conditions of a chuck-to-chuck distance of 100 mm, a temperature of 25° C. and a stretch rate of 10 mm/min.

In measuring the hygroscopic expansion coefficient, a film after standing at 25° C. and 80% RH for 2 hours or more is measured for the dimension L80 by using a pin gauge, a film after standing at 25° C. and 10% RH for 2 hours or more is measured for the dimension L10 by using a pin gauge, and the hygroscopic expansion coefficient is then calculated by the following formula:

(L10−L80)/(80% RH−10% RH)×1,000,000

In the cellulose acylate film of the present invention, the haze is preferably from 0.01 to 2%. The haze can be measured as follows.

The haze is measured using a sample (40 mm×80 mm) of the cellulose acylate film of the present invention according to JIS K6714 by a haze meter (HGM-2DP, manufactured by Suga Test Instruments Co., Ltd.) at 25° C. and 60% RH.

Also, in the cellulose acylate film of the present invention, the change in the mass when the film is left standing for 48 hours under the conditions of 80° C. and 90% RH is preferably from 0 to 5%.

In the cellulose acylate film of the present invention, the dimensional change when the film is left standing for 24 hours under the conditions of 60° C. and 95% RH, and the dimensional change when the film is left standing for 24 hours under the conditions of 90° C. and 5% RH, both are preferably from 0 to 5%.

From the standpoint of less allowing a liquid crystal display device to cause tint change due to aging, the photoelastic coefficient is preferably 50×10⁻¹³ cm²/dyne or less.

As for the specific measuring method, a cellulose acylate film sample (10 mm×100 mm) is applied with a tensile stress in the long axis direction and the retardation at this time is measured by an ellipsometer (M150, manufactured by JASCO Corporation). The photoelastic coefficient is calculated from the variation of retardation based on the stress.

### (Polarizing Plate)

The polarizing plate for use in the present invention is described below.

The polarizing plate for use in the present invention is preferably a polarizing plate where at least one sheet of the above-described cellulose acylate film is used as a protective film for a polarizer.

The polarizing plate usually comprises a polarizer and two transparent protective films disposed on both sides of the polarizer. In the present invention, the cellulose acylate film of the present invention is preferably used as at least one protective film. The another protective film may be an ordinary cellulose acetate film. The curling of the polarizing plate can be controlled by adjusting the relationship among the thickness, elastic modulus and hygroscopic expansion coefficient of the protective film on the liquid crystal cell side and the protective film on the side opposite the liquid crystal cell.

The polarizer of the polarizing plate includes an iodine-based polarizer, a dye-based polarizer using a dichromatic dye, and a polyene-based polarizer. The iodine-based polarizer and dye-based polarizer are generally produced by using a polyvinyl alcohol-based film. In the case of using the cellulose acylate film of the present invention as a polarizing plate protective film, the polarizing plate is not particularly limited in its production method and can be produced by a general method. For example, a method where the obtained cellulose acylate film is alkali-treated and laminated by using an aqueous solution of completely saponified polyvinyl alcohol to both surfaces of a polarizer produced by dipping a polyvinyl alcohol film in an iodine solution and stretching the film, may be used. Instead of an alkali treatment, an easy adhesion process described in JP-A-6-94915 and JP-A-6-118232 may be applied. Examples of the adhesive used for laminating the treated surface of the protective film to the polarizer include a polyvinyl alcohol-based adhesive such as polyvinyl alcohol and polyvinyl butyral, and a vinyl-based latex such as butyl acrylate. The polarizing plate is constituted by a polarizer and protective films protecting both surfaces of the polarizer, and may be constituted by further laminating a protect film to one surface of the polarizing plate and a separate film to the opposite surface. The protect film and separate film are used for the purpose of protecting the polarizing plate, for example, at the shipment of the polarizing plate or at the inspection of the product. In this case, the protect film is laminated for the purpose of protecting the polarizing plate surface and used on the side opposite the surface through which the polarizing plate is attached to a liquid crystal cell. The separate film is used for the purpose of covering the adhesive layer which adheres to a liquid crystal cell and used on the side of the surface through which the polarizing plate is attached to a liquid crystal cell.

The cellulose acylate film of the present invention is preferably laminated to a polarizer so that, as shown in FIG. 6, the transmission axis of the polarizer can agree with the slow axis of the cellulose acylate film (TAC1 in the Figure) of the present invention.

Incidentally, in the case of a polarizing plate produced as a polarizing plate in a cross-Nicol state, if the orthogonal precision between the slow axis of the cellulose acylate film of the present invention and the absorption axis (axis orthogonal to the transmission axis) of the polarizer exceeds 10, the polarization degree performance of the polarizing plate in a cross-Nicol state decreases to cause light-through and when combined with a liquid crystal cell, a sufficiently high black level or contrast cannot be obtained. Therefore, the slippage between the slow axis direction of the cellulose acylate film of the present invention and the transmission axis direction of the polarizing plate is preferably within 10, more preferably within 0.50.

In order to set the color tint in the black display state of a liquid crystal display device to an appropriate range, the color phases a* and b* in the cross-Nicol state of the polarizing plate are preferably −1.0≦a*≦2.0 and −1.0≦b*≦2.0, more preferably −0.5≦a*≦1.5 and −0.5≦b*≦1.5.

The color phases a* and b* of the polarizing plate can be determined from the definitions of the CIE 1976 L*a*b* color space by measuring the spectral transmittance in the visible region of the polarizing plate, and multiplying and integrating the measured spectral transmittance by a color-matching function to obtain tristimulus values X, Y and Z. Details are described in Iro Saigen Kogaku no Kiso (Basic of Color Reproduction Optics), Corona Sha.

Specifically, in a color measurement mode of spectrophotometer UV-3100 (manufactured by Shimadzu Corp.), the transmittance is measured under the following measuring conditions to calculate color phases of the polarizing plate. Measurement wavelength range: from 780 to 380 nm, scanning speed: medium, slit width: 2.0 nm, sampling pitch: 1.0 nm, light source: C light source, and viewing field: 2°. Here, two polarizing plates are combined by arranging the cell-side protective films to face each other and allowing respective transmission axes to run orthogonally and disposed such that the transmission axis of the polarizing plate makes an angle of 45° with respect to the normal direction (the direction of grating groove) in the sample room of the spectrophotometer.

### (Surface Treatment)

The cellulose acylate film of the present invention may be surface-treated depending on the case, whereby adhesion of the cellulose acylate film to respective functional layers (for example, undercoat layer and back layer) can be enhanced. Examples of the surface treatment which can be used include a glow discharge treatment, an ultraviolet irradiation treatment, a corona treatment, a flame treatment and an acid or alkali treatment. The glow discharge treatment as used herein may be a low-temperature plasma occurring in a low-pressure gas of 10⁻³ to 20 Torr. A plasma treatment in an atmospheric pressure is also preferred. The plasma-exciting gas means a gas that is plasma-excited under such a condition, and examples thereof include argon, helium, neon, krypton, xenon, nitrogen, carbon dioxide, fluorocarbons such as tetrafluoromethane, and a mixture thereof. These are described in detail in JIII Journal of Technical Disclosure, No. 2001-1745, pp. 30-32, Japan Institute of Invention and Innovation (Mar. 15, 2001). The atmospheric pressure plasma treatment attracting attention in recent years uses, for example, an irradiation energy of 20 to 500 Kgy at 10 to 1,000 Kev, preferably an irradiation energy of 20 to 300 Kgy at 30 to 500 Kev. Among these treatments, an alkali saponification treatment is preferred, and this is a very effective surface treatment for the cellulose acylate film.

The alkali saponification treatment is preferably performed by a method of dipping the cellulose acylate film directly in a bath containing a saponification solution or a method of coating a saponification solution on the cellulose acylate film. Examples of the coating method include a dip coating method, a curtain coating method, an extrusion coating method, a bar coating method and an E-type coating method. Since the saponification solution is coated on the cellulose acylate film, the solvent for the alkali saponification treatment coating solution is preferably selected from those having good wettability and keeping good surface state without forming irregularities on the cellulose acylate film surface. More specifically, an alcohol-based solvent is preferred, and isopropyl alcohol is more preferred. An aqueous solution of a surfactant may also be used as the solvent. The alkali in the alkali saponification coating solution is preferably an alkali dissolvable in the above-described solvent, more preferably KOH or NaOH. The pH of the saponification coating solution is preferably 10 or more, more preferably 12 or more. The reaction conditions at the alkali saponification are preferably room temperature and from 1 second to 5 minutes, more preferably from 5 seconds to 5 minute, still more preferably from 20 seconds to 30 minutes. After the alkali saponification reaction, the saponification solution-coated surface is preferably washed with water or washed with an acid and then with water.

The polarizing plate for use in the present invention is preferably a polarizing plate where at least one layer selected from a hardcoat layer, an antiglare layer and an antireflection layer is provided on the surface of the protective film on another side of the polarizing plate. That is, as shown in FIG. 7, a functional film such as antireflection layer is preferably provided on the protective film (TAC2) disposed on the side opposite the liquid crystal cell at the application of the polarizing plate to a liquid crystal display device, and at least one layer selected from a hardcoat layer, an antiglare layer and an antireflection layer is preferably provided as such a functional film. Incidentally, these layers need not be provided as individual layers but, for example, the function as an antiglare layer may be imparted to an antireflection layer or hardcoat layer, so that the antireflection layer can function both as an antireflection layer and as an antiglare layer.

As regards the respective functional layers for use in the polarizing plate of the present invention, the antireflection layer is described in [0158] and [0159] of JP-A-2007-140497, the light-scattering layer is described in [0160] and [0161] of the same patent publication, the antireflection layer (AR film) where a medium refractive index layer, a high refractive index layer and a low refractive index layer are stacked in this order, is described in [0162] and [0163] of the same patent publication, the hardcoat layer is described in [0164] and [0165] of the same patent publication, and these techniques can be utilized.

### (Liquid Crystal Display Device)

The liquid crystal display device of the present invention includes a liquid crystal display device using at least one polarizing plate having the protective film of the present invention (first embodiment), a VA-mode, OCB-mode or TN-mode liquid crystal display device using one polarizing plate having the protective film of the present invention for each of the top and the bottom of a cell (second embodiment), and a VA-mode liquid crystal display device using one polarizing plate having the protective film of the present invention only on the backlight side (third embodiment).

That is, the protective film of the present invention is advantageously used as an optically compensatory sheet. Also, the polarizing plate using the protective film is advantageously used for a liquid crystal display device. The protective film of the present invention can be used for liquid cells of various display modes. Various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic) have been proposed. Among these, VA mode and OCB mode can be preferably used.

In the VA-mode liquid crystal cell, rod-like liquid crystalline molecules are oriented substantially in the vertical alignment when a voltage is not applied.

The VA-mode liquid crystal cell includes (1) a strict VA-mode liquid crystal where rod-like liquid crystalline molecules are oriented substantially in the vertical alignment when not applying a voltage and oriented substantially in the horizontal alignment when applying a voltage (described in JP-A-2-176625), (2) a (MVA-mode) liquid crystal cell fabricated by modifying the VA mode into a multi-domain type for enlarging the viewing angle (described in SID97, Digest of Tech. Papers (Preprints), 28, 845 (1997)), (3) a liquid crystal cell in a mode (n-ASM-mode or CPA-mode) where rod-like liquid crystalline molecules are oriented substantially in the vertical alignment when not applying a voltage and oriented in the twisted multi-domain alignment when applying a voltage (described in Preprints of Nippon Ekisho Toronkai (Liquid Crystal Forum of Japan), 58-59 (1998)), and (4) a SURVAIVAL-mode liquid crystal cell (published in LCD International 98).

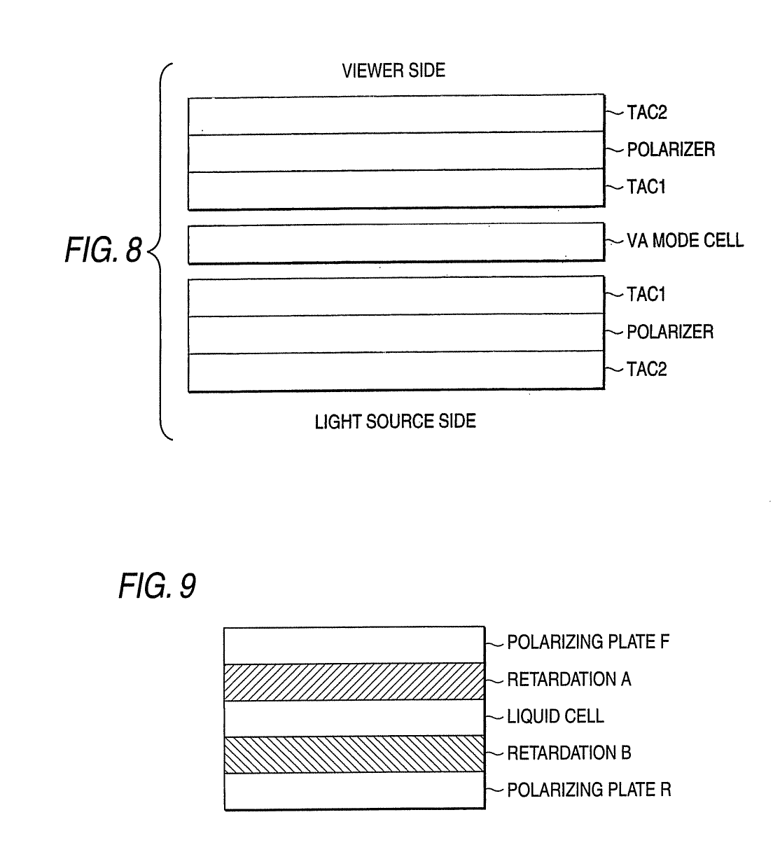

The VA-mode liquid crystal display device includes a liquid crystal device comprising, as shown in FIG. 8, a liquid crystal cell (VA-mode cell) and two polarizing plates (polarizing plates each comprising TAC1, polarizer and TAC2) disposed on both sides of the liquid crystal cell. Although not shown, the liquid cell carries a liquid crystal between two electrode substrates.

In the embodiment of the transmission-type liquid crystal display device of the present invention, the sheet-like protective film of the present invention is preferably used for the cellulose acylate film TAC1 of FIG. 8. In particular, it is preferred to use the protective film A of the present invention for the light source-side TAC1 and the protective film B of the present invention for the viewer-side TAC1. As for the lamination to a liquid crystal cell, the cellulose acylate film (TAC1) is preferably laminated to the VA cell side. In the case of using the protective film of the present invention only for the protective film (between the liquid crystal cell and the polarizer) of one polarizing plate, the protective film may be laminated on whichever side the upper polarizing plate (view side) or the lower polarizing plate (backlight side). However, it is a more preferred embodiment to use the protective film of the present invention for the polarizing plate protective films on both sides.

The protective film (TAC2) in FIG. 8 may be a commercially available cellulose acylate film and this is preferably thinner than the cellulose acylate film of the present invention. For example, the thickness is preferably from 40 to 80 μm. Examples of the commercially available cellulose acylate film include, but are not limited to, KC4UX2M (produced by Konica Opt, Inc., 40 μm), KC5UX (produced by Konica Opt, Inc., 60 μm) and TD80 (produced by Fuji Photo Film Co., Ltd., 80 μm).

### EXAMPLES

The present invention is basically described below by referring to Examples, but the present invention is not limited to these Examples.

### Example 1

### [Production of Viewing-Side Polarizing Plate Protective Films (F-1 to F-8)]

### (1) Production of F-1

Respective components shown in Table 1 below were mixed to prepare a cellulose acylate solution. This cellulose acylate solution was cast on a metal support, and the obtained web was separated from the band support to produce Transparent Film F-1. The film thickness was 70 μm.

TABLE 1
Component

| | | |
|---|---|---|
| Cellulose acylate with an acetyl | 100 | parts by weight |
| substitution degree of 2.87 | | |
| Triphenyl phosphate | 5 | parts by weight |
| Biphenyl phosphate | 3 | parts by weight |
| Retardation Controlling Agent A | 6 | parts by weight |
| Retardation Controlling Agent B | 5 | parts by weight |
| Methylene chloride | 544 | parts by weight |
| Methanol | 81 | parts by weight |
| Matting agent (AEROSIL R972, | 0.05 | parts by weight |
| produced by Nippon Aerosil Co., | | |
| Ltd.) | | |

(Retardation Controlling Agent A)

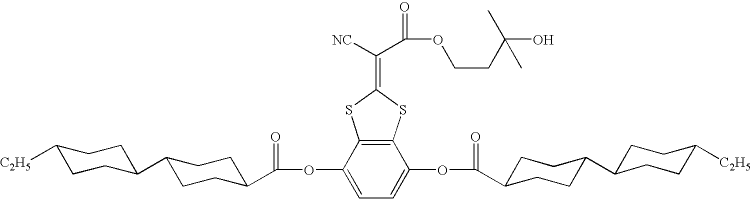

(Retardation Controlling Agent B)

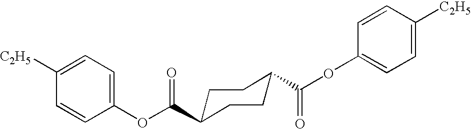

### (Evaluation of Optical Performance)

The Re retardation value and Rth retardation value at wavelengths of 450 nm, 550 nm and 630 nm were measured at 25° C. and 60% RH. Here, in the film of the present invention, Rth(λ) was calculated by applying an average refractive index of 1.48. The measured film was laminated to a glass plate through a pressure-sensitive adhesive, and the Re retardation value and Rth retardation value at wavelengths of 450 nm, 550 nm and 630 nm were similarly measured in a state of the film being heated until the film surface temperature reached 60° C. With respect to F-1 to F-8, the retardation measurement was performed in the same manner.

### (2) Production of F-2

The same cellulose acylate solution as in F-1 was cast on a metal support, and the obtained web was separated from the band support to produce Transparent Film F-2. The film thickness was 92 μm.

### (3) Production of F-3

Respective components shown in Table 2 below were mixed to prepare a cellulose acylate solution. This cellulose acylate solution was cast on a metal support, and the obtained web was separated from the band support to produce Transparent Film F-3. The film thickness was 80 μm.

TABLE 2

| Component | | |
|---|---|---|
| Cellulose acylate with an acetyl | 100 | parts by weight |
| substitution degree of 2.94 | | |
| Triphenyl phosphate | 8 | parts by weight |
| Biphenyl phosphate | 3 | parts by weight |
| Retardation Controlling Agent C | 2 | parts by weight |
| Methylene chloride | 516 | parts by weight |
| Methanol | 77 | parts by weight |
| Matting agent (AEROSIL R972, | 0.05 | parts by weight |
| produced by Nippon Aerosil Co., | | |
| Ltd.) | | |

(Retardation Controlling Agent C)

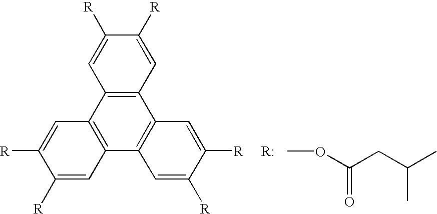

### (4) Production of F-4

The same cellulose acylate solution as in F-3 except for changing the amount added of Retardation Controlling Agent C to 2.6% was cast on a metal support, and the obtained web was separated from the band support to produce Transparent Film F-4. The film thickness was 80 μm.

### (5) Production of F-5

Commercially available cellulose acylate film FUJI-TAC TDY80UL (produced by Fujifilm Corp.) was used as F-5.

### (6) Production of F-6

Respective components shown in Table 3 below were mixed to prepare a cellulose acylate propionate solution. This cellulose acylate propionate solution was cast on a metal support at a dope temperature of 30° C., and the obtained web was separated from the band support to produce Transparent Film F-6. The film thickness was 40 μm.

TABLE 3
Component

| | | |
|---|---|---|
| Cellulose acylate propionate with | 100 | parts by weight |
| the substitution degree of acetyl | | |
| group being 2.00 and the | | |
| substitution degree of propionyl | | |
| group being C | | |
| Triphenyl phosphate | 8.5 | parts by weight |
| Ethylphthalyl ethyl glycolate | 2 | parts by weight |
| TINUVIN 326 (produced by Ciba | 0.5 | parts by weight |
| Specialty Chemicals Corp.) | | |
| TINUVIN 109 (produced by Ciba | 0.3 | parts by weight |
| Specialty Chemicals Corp.) | | |
| TINUVIN 171 (produced by Ciba | 0.4 | parts by weight |
| Specialty Chemicals Corp.) | | |
| Methylene chloride | 298 | parts by weight |
| Methanol | 61 | parts by weight |

### (7) Production of F-7

A 100 μm-thick norbornene-based film, ZEONOR ZF14 (produced by Nippon Zeon Co., Ltd.), was 15% biaxially stretched at 150° C. to produce F-7. The film thickness was 80 μm. The retardation values were measured in the same manner as in F-1 except for changing the average refractive index to 1.52.

### (8) Production of F-8

Respective components shown in Table 4 below were mixed to prepare a cellulose acylate solution. This cellulose acylate solution was cast on a metal support, and the obtained web was separated from the band support to produce Transparent Film F-8. The film thickness was 80 μm.

TABLE 4

| Component | | |
|---|---|---|
| Cellulose acylate with an acetyl | 100 | parts by weight |
| substitution degree of 2.87 | | |
| Triphenyl phosphate | 8 | parts by weight |
| Biphenyl phosphate | 4 | parts by weight |
| Retardation Controlling Agent D | 4 | parts by weight |
| Methylene chloride | 530 | parts by weight |
| Methanol | 79 | parts by weight |
| Matting agent (AEROSIL R972, | 0.05 | parts by weight |
| produced by Nippon Aerosil Co., | | |
| Ltd.) | | |

(Retardation Controlling Agent C)

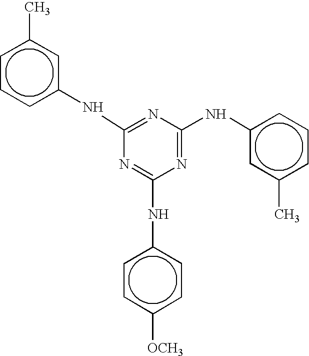

The retardation measurement results of viewing-side polarizing plate protective films F-1 to F-8 obtained above are shown in Table 5 below.

TABLE 5

| Example 1 | F-1 | F-2 | F-3 | F-4 | F-5 | F-6 | F-7 | F-8 |
|---|---|---|---|---|---|---|---|---|
| ReB (450) 25° C. | 4 | 7 | 8 | 8 | 5 | 5 | 0 | 0 |
| ReB (550) 25° C. | 5 | 8 | 8 | 8 | 5 | 5 | 0 | 0 |
| ReB (630) 25° C. | 5 | 8 | 8 | 8 | 5 | 5 | 0 | 0 |
| RthB (450) 25° C. | 37 | 90 | 112 | 148 | 44 | 44 | 46 | 115 |
| RthB (550) 25° C. | 45 | 110 | 110 | 145 | 45 | 45 | 45 | 110 |
| RthB (630) 25° C. | 47 | 116 | 110 | 144 | 46 | 46 | 45 | 110 |
| RthB (450)/RthB (550) | 0.82 | 0.82 | 1.02 | 1.02 | 0.98 | 0.98 | 1.01 | 1.05 |
| RthB (630)/RthB (550) | 1.06 | 1.06 | 1.00 | 1.00 | 1.02 | 1.02 | 0.99 | 1.00 |
| ReB (550) 60° C. | 3 | 6 | 6 | 7 | 17 | 16 | 0 | 12 |
| RthB (550) 60° C. | 25 | 90 | 90 | 119 | 80 | 83 | 65 | 145 |

### Example 2

### [Production of Backlight-Side Polarizing Plate Protective Films (R-1 and R-2)]

### (1) Production of R-1

Respective components shown in Table 6 below were mixed to prepare a cellulose acylate solution. This cellulose acylate solution was cast on a metal support. The film stripped off from the metal support in a state of the residual solvent amount being from 25 to 35 mass % was 3% stretched in the longitudinally direction within the section from stripping to a tenter under the conditions of a stretching temperature of about Tg−5° C. to Tg+5° C. and then stretched in the width direction at a stretch ratio of 32% by using a tenter and immediately after the transverse stretching, the film was shrunk in the width direction at a ratio of 7% and then removed from the tenter to prepare a cellulose acylate film. The film thickness was 80 μm.

TABLE 6
Component

| | | |
|---|---|---|
| Cellulose acylate with an acetyl | 100 | parts by weight |
| substitution degree of 2.81 | | |
| Triphenyl phosphate | 7.8 | parts by weight |
| Biphenyl phosphate | 3.9 | parts by weight |
| Retardation Controlling Agent D | 6.4 | parts by weight |
| Methylene chloride | 493 | parts by weight |
| Methanol | 74 | parts by weight |
| Matting agent (AEROSIL R972, | 0.05 | parts by weight |
| produced by Nippon Aerosil Co., | | |
| Ltd.) | | |

### (Evaluation of Optical Performance)

The Re retardation value and Rth retardation value at wavelengths of 450 nm, 550 nm and 630 nm were measured at 25° C. and 60% RH. Here, in the film of the present invention, Rth(λ) was calculated by applying an average refractive index of 1.48.

### (2) Production of R-2

Respective components shown in Table 7 below were mixed to prepare a cellulose acylate solution. This cellulose acylate solution was cast on a metal support. The film stripped off from the metal support in a state of the residual solvent amount being from 25 to 35 mass % was 5% stretched in the longitudinally direction within the section from stripping to a tenter under the conditions of a stretching temperature of about Tg−5° C. to Tg+5° C. and then stretched in the width direction at a stretch ratio of 25% by using a tenter and immediately after the transverse stretching, the film was shrunk in the width direction at a ratio of 2% and then removed from the tenter to prepare a cellulose acylate film. The film thickness was 60 μm. The retardation values were measured in the same manner as R-1.

TABLE 7
Component

| | | |
|---|---|---|
| Cellulose acylate with an acetyl | 100 | parts by weight |
| substitution degree of 2.94 | | |
| Triphenyl phosphate | 5 | parts by weight |
| Biphenyl phosphate | 3 | parts by weight |
| Retardation Controlling Agent A | 6 | parts by weight |
| Retardation Controlling Agent B | 5 | parts by weight |
| Methylene chloride | 544 | parts by weight |
| Methanol | 81 | parts by weight |
| Matting agent (AEROSIL R972, | 0.05 | parts by weight |
| produced by Nippon Aerosil Co., | | |
| Ltd.) | | |

### (3) Production of R-3

A film obtained by casting in the same manner as R-2 was 30% stretched in the width direction, and this film was designated as R-3. The film thickness was 45 μm. The retardation values were measured in the same manner as R-1.

### (4) Production of R-4

A cellulose acylate propionate solution produced in the same manner as F6 was cast on a metal support. The film stripped off from the metal support in a state of the residual solvent amount being from 25 to 35 mass % was 125% stretched in the longitudinal direction within the section from stripping to a tenter under the conditions of a stretching temperature of about Tg−5° C. to Tg+5° C. to prepare a cellulose propionate film. The film thickness was 74 μm.

The retardation values were measured in the same manner as R-1.

The retardation measurement results of Backlight-Side Polarizing Plate Protective Films R-1 to R-4 are shown in Table 8 below.

TABLE 8

| Example 2 | R-1 | R-2 | R-3 | R-4 |
|---|---|---|---|---|
| ReA(450)25° C. | 58 | 86 | 86 | 97 |
| ReA(550)25° C. | 55 | 100 | 100 | 100 |
| ReA(630)25° C. | 54 | 104 | 104 | 101 |
| RthA(450)25° C. | 209 | 105 | 97 | 122 |
| RthA(550)25° C. | 200 | 125 | 115 | 125 |
| RthA(630)25° C. | 200 | 130 | 120 | 126 |
| ReA(450)/ReA(550) | 1.05 | 0.86 | 0.86 | 0.97 |
| ReA(630)/ReA(550) | 0.99 | 1.04 | 1.04 | 1.01 |

### Example 3

A 80 μm-thick polyvinyl alcohol (PVA) film was dyed by dipping it in an aqueous potassium iodide solution having a potassium iodide concentration of 2 mass % at 30° C. for 60 seconds, then longitudinally stretched to 5 times the original length while dipping the film in an aqueous boric acid solution having a boric acid concentration of 4 mass % for 60 seconds, and dried at 50° C. for 4 minutes to obtain Polarizer A of 20 μm in thickness.

Also, a 80 μm-thick polyvinyl alcohol (PVA) film was dyed by dipping it in an aqueous potassium iodide solution having a potassium iodide concentration of 12 mass % at 30° C. for 60 seconds, then longitudinally stretched to 5 times the original length while dipping the film in an aqueous boric acid solution having a boric acid concentration of 4 mass % for 60 seconds, and dried at 50° C. for 4 minutes to obtain Polarizer B of 20 μm in thickness.

The protective films produced in Examples 1 and 2 shown in Tables 5 and 8 and a commercially available cellulose acylate film, FUJI-TAC TDY80UL (produced by Fuji Photo Film Co., Ltd.), each was dipped in an aqueous 1.5 mol/l sodium hydroxide solution at 55° C., and then sodium hydroxide was thoroughly washed out with water. Subsequently, each film was dipped in an aqueous 0.005 mol/l dilute sulfuric acid solution at 35° C. for 1 minute, and then the aqueous dilute sulfuric acid solution was thoroughly washed out by dipping the film in water. Finally, the sample was thoroughly dried at 120° C.

After such a saponification treatment, each protective film produced in Examples 1 and 2 and the commercially available cellulose acylate film, FUJI-TAC TDY80UL (produced by Fuji Photo Film Co., Ltd.), were laminated using a polyvinyl alcohol-based adhesive to sandwich a polarizer, whereby Polarizing Plates FH-1 to FH-8 and RH-1 to RH-4 were obtained. The polarizer and each protective film produced in Examples 1 and 2 except for R-4 were laminated together such that the MD direction of the polarizer agrees with the MD direction of the protective film. R-4 was laminated to cross MD directions at right angles.

### Example 4

### [Production of Liquid Crystal Display Device]

After stripping off the polarizing plates and retardation plates on the front and back sides of a commercially available 40-inch VA-mode liquid crystal television set (manufactured by SONY Corp.), the television was used as a liquid crystal cell. The Δnd value of this liquid crystal cell was 300 nm at 25° C. and 225 nm at 60° C.

According to the construction shown in Table 9 below, Polarizing Plates FH-1 to FH-8 and RH-1 to RH-4 produced were laminated to the liquid crystal cell through a pressure-sensitive adhesive to produce a liquid crystal display device shown in FIG. 9. Here, a cross-Nicol arrangement was employed, where the transmission axis of the polarizing plate on the viewer side ran in the up/down direction and the transmission axis of the polarizing plate on the backlight side ran in the right/left direction.

TABLE 9

| | | Construction | | | | | | | | |
|---|---|---|---|---|---|---|---|---|---|---|
| | | 1 | 2 | 3 | 4 | 5 | 6 | 7 | 8 | 9 |
| Polarizing | Viewer side | FH-1 | FH-2 | FH-3 | FH-4 | FH-3 | FH-5 | FH-6 | FH-7 | FH-8 |
| plate | Backlight | RH-1 | RH-2 | RH-2 | RH-3 | RH-4 | RH-1 | RH-1 | RH-1 | RH-1 |
| | side | | | | | | | | | |
| Display | CR (60°) 25° C. | 55 | 85 | 86 | 88 | 86 | 55 | 55 | 56 | 85 |
| performance | CR (60°) 60° C. | 52 | 77 | 78 | 80 | 77 | 30 | 29 | 35 | 57 |
| | Δu′v′ 25° C. | 0.09 | 0.04 | 0.04 | 0.04 | 0.05 | 0.09 | 0.09 | 0.09 | 0.09 |
| | Δu′v′ 60° C. | 0.09 | 0.05 | 0.04 | 0.04 | 0.04 | 0.13 | 0.13 | 0.12 | 0.12 |

### Example 5

### [Measurement of Display Performance]

The brightness and chromaticity of black display and white display were measured using a measuring apparatus (EZ-Contrast 160D, manufactured by ELDIM) in a dark room adjusted to 25° C. and 60%, and the color shift and contrast ratio at black display were calculated. Furthermore, the temperature in the dark room was set to 60%, and the color shift and contrast ratio were calculated in the same manner. The results are shown in Table 9. As for the color shift and contrast ratio at black display, the following indexes were used.

### [Contrast Ratio]

The average of contrast ratios for azimuthal angles of 450/1350/2250/3150 at a polar angle of 600 was indicated by CR.

### [Color Shift]

The maximum value and minimum value of u′ from a u′v′ chromaticity diagram when the view field was rotated in an azimuthal angle of 0 to 360° at a polar angle 60° are indicated by u′(max) and u′(min), the maximum value and minimum value of v′ are indicated by v′(max) and v′(min), and Δu′v′ was defined according to the following formula.

Δu′v′={(u′(max)²−u′(min)²)+(v′(max)²−v′(min)²)}^{0.5}

As seen from the results in Table 9, the liquid crystal display device having mounted therein each of FH-1 to FH-4 of which viewing-side Rth retardation value exhibits negative characteristics for the temperature (Constructions 1 to 5, the present invention) gives good values in terms of contrast ratio at 60° C. and color shift at the black display time as compared with the liquid crystal display device having mounted therein each of FH-5 to FH-8 of which viewing-side Rth retardation value exhibits positive characteristic for the temperature (Constructions 6 to 9, Comparative Examples).

What is claimed is:

1. A liquid crystal display device comprising:
a liquid crystal cell; and
a pair of polarizing plates sandwiching the liquid crystal cell and each comprising a polarizer and a protective film provided on a side of the liquid crystal cell, in which transmission axes of the pair of polarizing plates are orthogonally arranged,
wherein Rth(λ) of at least one of the protective films provided on the liquid crystal cell side of the polarizing plates has negative characteristics for ambient temperature, in which Rth(λ) represents a retardation in a thickness direction measured at a wavelength of λ nm.

2. The liquid crystal display device as claimed in claim 1, wherein ReA(λ) and RthA(λ) of a protective film A provided on the liquid crystal cell side of one of the pair of polarizing plates each increases as the wavelength becomes larger in a wavelength range of from 400 to 700 nm and RthB(λ) of a protective film B provided on the liquid crystal cell side of another of the pair of polarizing plates decreases as the wavelength becomes larger in a wavelength range of from 400 to 700 nm and has negative characteristics for ambient temperature, wherein ReA(λ) represents an in-plane retardation of the protective film A measured at a wavelength of λ nm, RthA(λ) represents a retardation of the protective film A in a thickness direction measured at a wavelength of λ nm, and RthB(λ) represents a retardation of the protective film B in a thickness direction measured at a wavelength of λ nm.

3. The liquid crystal display device as claimed in claim 2, wherein ReA(λ) and RthA(λ) of the protective film A, ReB(λ) and RthB(λ) of the protective film B and λnd of the liquid crystal cell satisfy the following formulae:
0.5≦RthA(550)/ReA(550)≦10 (i)
30≦RthA(550)≦400 (ii)
0≦ReB(550)≦20 (iii)
0≦RthB(550)≦150 (iv)
200≦Δnd≦800 (v)
wherein Δn is a difference (ne-no) between extraordinary light refractive index ne and ordinary light refractive index no, d is cell gap (unit: nm) of the liquid crystal cell, and ReB(λ) represents an in-plane retardation of the protective film B measured at a wavelength of λ nm.

4. The liquid crystal display device as claimed in claim 2, wherein the protective film B is provided on a viewing-side substrate of the liquid crystal cell.

5. The liquid crystal display device as claimed in claim 2, wherein the protective film B is substantially made from a cellulose acylate obtained by substituting an acyl group having 2 or more carbon atoms for a hydroxyl group of a glucose unit constituting a cellulose, and the cellulose acylate film satisfies the following formulae (vi) and (vii):
2.0≦DS2+DS3+DS6≦3.0 Formula (vi):
DS6/(DS2+DS3+DS6)≧0.315 Formula (vii):
Wherein DS2 represents a substitution degree by an acyl group for the hydroxyl group at a 2-position of the glucose unit, DS3 represents a substitution degree by an acyl group for the hydroxyl group at a 3-position and DS6 represents a substitution degree by an acyl group for the hydroxyl group at a 6-position.

6. The liquid crystal display device as claimed in claim 3, wherein the protective film B is substantially made from a cellulose acylate obtained by substituting an acyl group having 2 or more carbon atoms for a hydroxyl group of a glucose unit constituting a cellulose, and the cellulose acylate film satisfies the following formulae (vi) and (vii):
2.0≦DS2+DS3+DS6≦3.0 Formula (vi):
DS6/(DS2+DS3+DS6)≧0.315 Formula (vii):
Wherein DS2 represents a substitution degree by an acyl group for the hydroxyl group at a 2-position of the glucose unit, DS3 represents a substitution degree by an acyl group for the hydroxyl group at a 3-position and DS6 represents a substitution degree by an acyl group for the hydroxyl group at a 6-position.

7. The liquid crystal display device as claimed in claim 4, wherein the protective film B is substantially made from a cellulose acylate obtained by substituting an acyl group having 2 or more carbon atoms for a hydroxyl group of a glucose unit constituting a cellulose, and the cellulose acylate film satisfies the following formulae (vi) and (vii):
2.0≦DS2+DS3+DS6≦3.0 Formula (vi):
DS6/(DS2+DS3+DS6)≧0.315 Formula (vii):
Wherein DS2 represents a substitution degree by an acyl group for the hydroxyl group at a 2-position of the glucose unit, DS3 represents a substitution degree by an acyl group for the hydroxyl group at a 3-position and DS6 represents a substitution degree by an acyl group for the hydroxyl group at a 6-position.

8. The liquid crystal display device as claimed in claim 2, wherein the protective film B comprises at least one member selected from a plasticizer, an ultraviolet absorber, a release accelerator, a dye and a matting agent.

9. The liquid crystal display device as claimed in claim 3, wherein the protective film B comprises at least one member selected from a plasticizer, an ultraviolet absorber, a release accelerator, a dye and a matting agent.

10. The liquid crystal display device as claimed in claim 2, wherein the protective film B comprises a retardation controlling agents which is a rod-like compound or a discotic compound.

11. The liquid crystal display device as claimed in claim 3, wherein the protective film B comprises a retardation controlling agents which is a rod-like compound or a discotic compound.

12. The liquid crystal display device as claimed in claim 10, wherein the retardation controlling agent is a compound exhibiting crystallinity.

13. The liquid crystal display device as claimed in claim 11, wherein the retardation controlling agent is a compound exhibiting crystallinity.

14. The liquid crystal display device as claimed in claim 1, wherein the liquid crystal cell is in a vertically aligned mode.

15. The liquid crystal display device as claimed in claim 2, wherein the liquid crystal cell is in a vertically aligned mode.
